(19) United States
(12) Patent Application Publication
(10) Pub. No.: US 2026/0211534 A1
(43) Pub. Date: Jul. 23, 2026

(54) METHOD FOR GENERATING DATA DASHBOARD, ELECTRONIC DEVICE, AND NON-TRANSITORY COMPUTER-READABLE STORAGE MEDIUM

(71) Applicant: Beijing Volcano Engine Technology Co., Ltd., Beijing (CN)

(72) Inventors: Xiaokang WEN, Beijing (CN); Jiani ZHANG, Beijing (CN); Feng QIAN, Beijing (CN); Lingmin XU, Beijing (CN); Peng ZHOU, Beijing (CN); Chenxi MA, Beijing (CN); Bing YANG, Beijing (CN); Jida WANG, Beijing (CN); Fei XIE, Beijing (CN)

(21) Appl. No.: 19/431,315

(22) Filed: Dec. 23, 2025

(30) Foreign Application Priority Data
Jan. 21, 2025 (CN) 202510097027.5

(51) Int. Cl. G06F 3/0483; G06F 3/04845

(52) U.S. Cl. CPC G06F 3/0483; G06F 3/04845

(57) ABSTRACT

A method for generating a data dashboard, an electronic device, and a non-transitory computer-readable storage medium are provided. The method includes: displaying a dashboard creation page, where a first generation control and a corresponding first configuration area are displayed on the dashboard creation page, the first generation control corresponds to a language model, and a first configuration item of at least one first construction parameter of a dashboard is provided in the first configuration area; obtaining, in response to a configuration operation for the first configuration item, first construction information; and displaying, in response to an interaction operation for the first generation control, a first dashboard on a dashboard display page, where the first dashboard includes at least one first chart, and the at least one first chart is generated by the language model based on the first construction information.

### CROSS-REFERENCE TO RELATED APPLICATION

This application claims the priority to and benefits of Chinese Patent Application, No.2025100970275, which was filed on January 21, 2025. The aforementioned patent application is hereby incorporated by reference in its entirety.

### TECHNICAL FIELD

The present disclosure relates to the field of data processing technologies, in particularly, to a method for generating a data dashboard, an electronic device, and a non-transitory computer-readable storage medium.

### BACKGROUND

In the related art, when a data dashboard is built, usually, a chart is selected first, and then a draft is manually drawn or a document is created for conception, to build the data dashboard. Then, the data dashboard is adjusted by dragging and dropping components, aligning pixels, repeatedly modifying the style, and the like, to obtain a final data dashboard. A long time is required to generate the data dashboard.

### SUMMARY

In view of this, the present disclosure provides a method for generating a data dashboard, an electronic device, and a non-transitory computer-readable storage medium.

According to a first aspect, the present disclosure provides a method for generating a data dashboard, where the method includes:

displaying a dashboard creation page, where a first generation control and a corresponding first configuration area are displayed on the dashboard creation page, the first generation control corresponds to a language model, and a first configuration item of at least one first construction parameter of a dashboard is provided in the first configuration area;

obtaining, in response to a configuration operation for the first configuration item, first construction information ; and

displaying, in response to an interaction operation for the first generation control, a first dashboard on a dashboard display page, where the first dashboard includes at least one first chart, and the at least one first chart is generated by the language model based on the first construction information.

According to a second aspect, the present disclosure provides an apparatus for generating a data dashboard, where the apparatus includes:

a page display module, configured to display a dashboard creation page, where a first generation control and a corresponding first configuration area are displayed on the dashboard creation page, the first generation control corresponds to a language model, and a first configuration item of at least one first construction parameter of a dashboard is provided in the first configuration area;

a parameter configuration module, configured to obtain first construction information in response to a configuration operation for the first configuration item; and

a dashboard generation module, configured to display a first dashboard on a dashboard display page in response to an interaction operation for the first generation control, where the first dashboard includes at least one first chart, and the at least one first chart is generated by the language model based on the first construction information.

According to a third aspect, the present disclosure provides an electronic device, including: a memory and a processor, where the memory is communicatively connected to the processor, the memory is configured to store computer instructions, and the processor executes the computer instructions to implement the foregoing method for generating a data dashboard.

According to a fourth aspect, the present disclosure provides a non-transitory computer-readable storage medium storing computer instructions, where the computer instructions are used to enable a computer to perform the foregoing method for generating a data dashboard.

According to a fifth aspect, the present disclosure provides a computer program product including computer instructions, where the computer instructions are used to enable a computer to perform the foregoing method for generating a data dashboard.

### BRIEF DESCRIPTION OF DRAWINGS

To describe the technical solutions in the embodiments of the present disclosure more clearly, the following briefly describes the drawings used in describing the embodiments or the prior art. Apparently, the drawings in the following description show some embodiments of the present disclosure, and other drawings may also be obtained by a person of ordinary skill in the art according to these drawings without creative efforts.

FIG. 1 is a schematic flowchart of a method for generating a data dashboard according to an embodiment of the present disclosure;

FIG. 2 is a schematic diagram of a dashboard creation page according to an embodiment of the present disclosure;

FIG. 3 is a schematic diagram of an analysis panel according to an embodiment of the present disclosure;

FIG. 4 is a schematic diagram of displaying a function control according to an embodiment of the present disclosure;

FIG. 5A to FIG. 5D are schematic diagrams of operating different function controls according to an embodiment of the present disclosure;

FIG. 6 is a schematic diagram of an operating beautification function according to an embodiment of the present disclosure;

FIG. 7 is a schematic diagram of a chart container according to an embodiment of the present disclosure;

FIG. 8 is a schematic diagram of displaying a construction function according to an embodiment of the present disclosure;

FIG. 9A to FIG. 9E are schematic diagrams of displaying different construction functions according to an embodiment of the present disclosure;

FIG. 10 is a schematic diagram of displaying a layout function according to an embodiment of the present disclosure;

FIG. 11 is a block diagram of an apparatus for generating a data dashboard according to an embodiment of the present disclosure; and

FIG. 12 is a block diagram of an electronic device according to an embodiment of the present disclosure.

### DETAILED DESCRIPTION

To make the objectives, technical solutions, and advantages of the embodiments of the present disclosure clearer, the technical solutions in the embodiments of the present disclosure will be described clearly and comprehensively with reference to the drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the scope of protection of the present disclosure.

It may be understood that before the technical solutions disclosed in the embodiments of the present disclosure are used, the user shall be informed of the type, range of use, use scenarios, etc., of personal information involved in the present disclosure in an appropriate manner and the authorization of the user shall be obtained in accordance with relevant laws and regulations.

In the related art, when a data dashboard is built, usually, a chart is selected first, and then a draft is manually drawn or a document is created for conception, to build the data dashboard. Then, the data dashboard is adjusted by dragging and dropping components, aligning pixels, repeatedly modifying the style, and the like, to obtain a final data dashboard. A long time is required to generate the data dashboard.

In view of this, according to an embodiment of the present disclosure, an embodiment of a method for generating a data dashboard is provided. It should be noted that the steps shown in the flowchart of the drawings may be performed in a computer system, such as a set of computer-executable instructions. Furthermore, although a logical order is shown in the flowchart, in some cases, the steps shown or described may be performed in an order different from that herein.

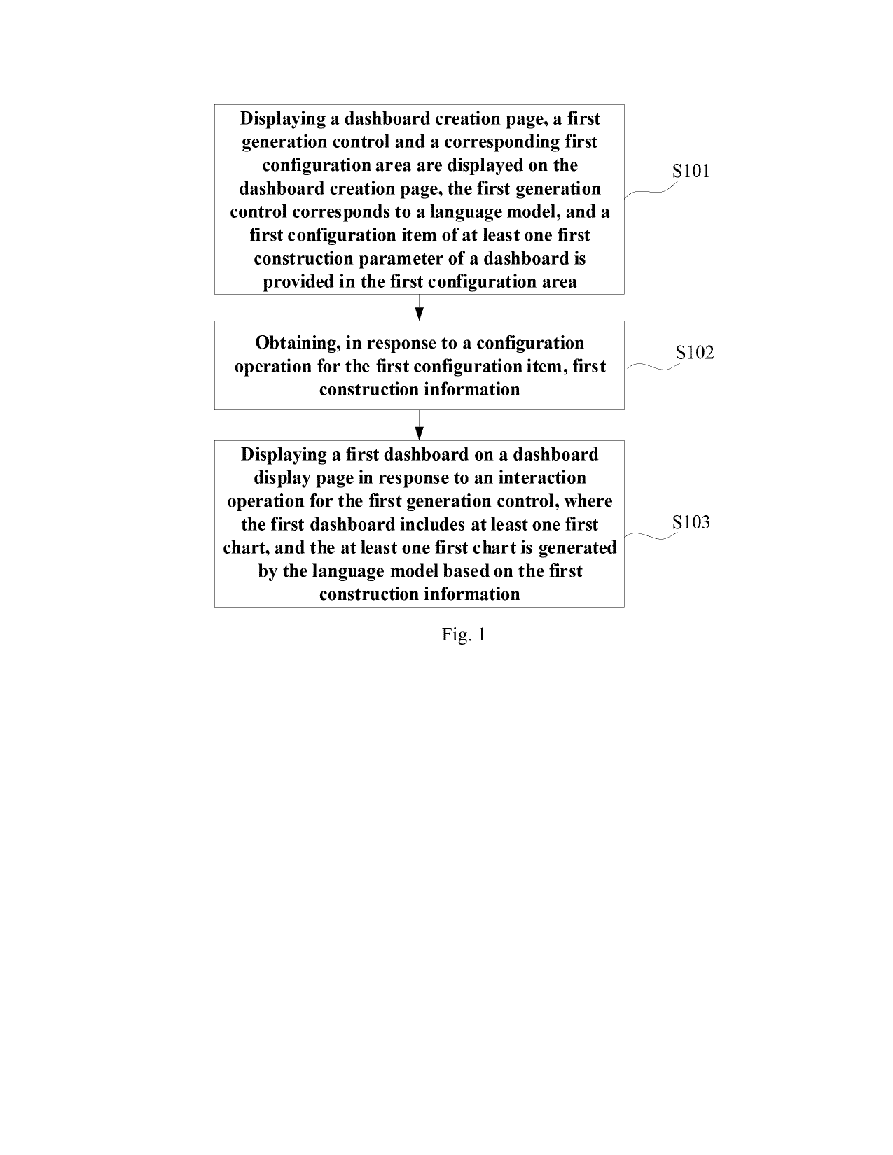

In this embodiment, a method for generating a data dashboard is provided, and the method may be used for a mobile terminal, such as a mobile phone, a tablet computer, etc. FIG. 1 is a schematic flowchart of a method for generating a data dashboard according to an embodiment of the present disclosure. As shown in FIG. 1, the process includes the following steps.

Step S101: displaying a dashboard creation page, a first generation control and a corresponding first configuration area are displayed on the dashboard creation page, the first generation control corresponds to a language model, and a first configuration item of at least one first construction parameter of a dashboard is provided in the first configuration area.

For example, the dashboard creation page is displayed in response to a dashboard creation instruction. A construction control corresponding to the language model is displayed on the dashboard creation page, and the first configuration area is displayed in response to an interaction operation for the construction control.

For example, a configuration item of a descriptive parameter is further displayed on the dashboard creation page. For example, the configuration item of the descriptive parameter is a name, a path, a risk level, or whether user information is included in the dashboard.

For example, the first construction parameter includes at least one selected from the group consisting of a dataset, a related field, an analysis idea, and a layout requirement. Furthermore, the first construction parameter further includes whether to prioritize the match of an existing chart. If the match of the existing chart is prioritized, the existing chart is first displayed in the constructed first dashboard, and then the chart generated this time is displayed. In this way, by specifying the dataset, the chart, the analysis idea, the layout requirement, and the like, the dashboard may be built from scratch.

It should be noted that the above first construction parameter is only an example, and the first construction parameter may be adjusted based on an actual requirement. This is not limited herein.

Step S102: obtaining, in response to a configuration operation for the first configuration item, first construction information.

It should be noted that because a data source is required when the dashboard is created, the dataset is a required item, and the first construction parameter other than the dataset is an optional item.

Step S103: displaying a first dashboard on a dashboard display page in response to an interaction operation for the first generation control, where the first dashboard includes at least one first chart, and the at least one first chart is generated by the language model based on the first construction information.

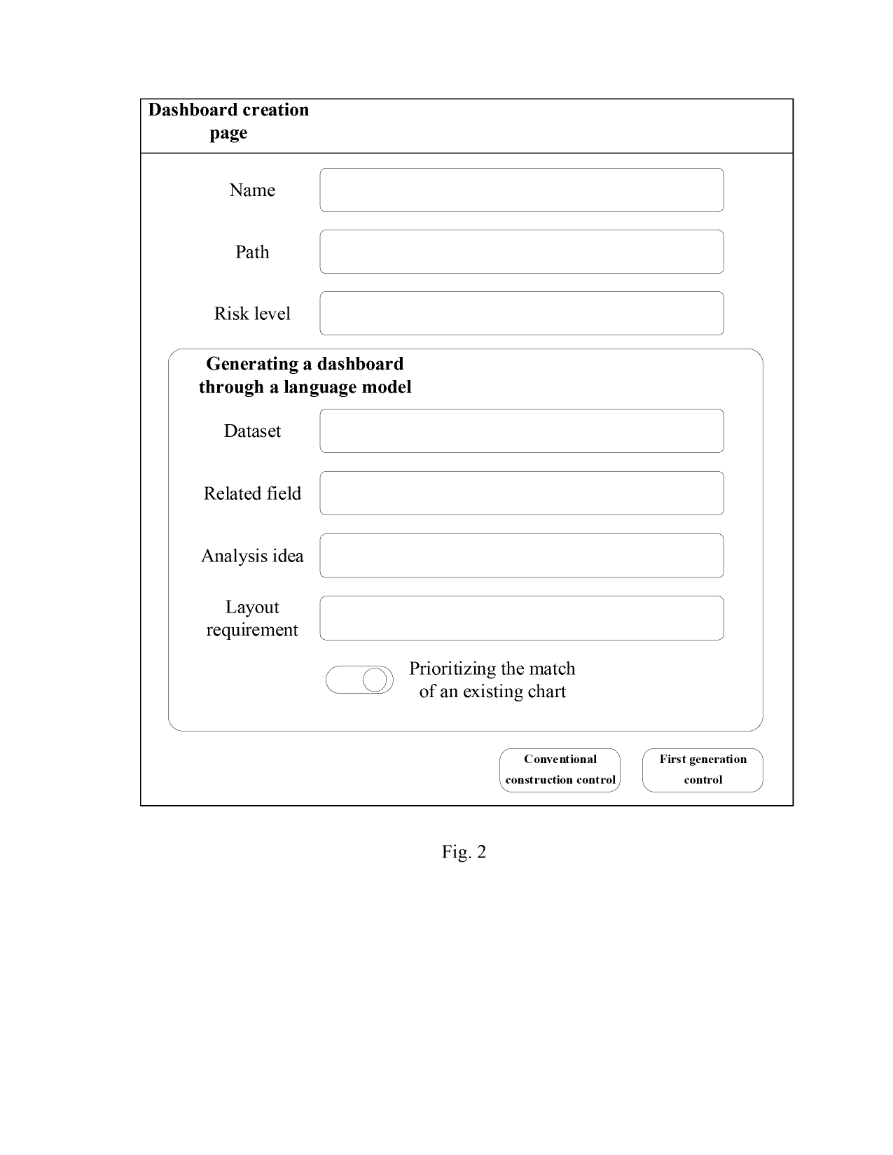

It should be noted that the first construction information obtained through configuration in the first configuration area is used for constructing the dashboard through the language model. As shown in FIG. 2, a conventional construction control is further displayed on the dashboard creation page. If the conventional construction control is interacted with, the first construction information becomes invalid, and a normal creation process of the dashboard is entered.

According to the method for generating a data dashboard provided in this embodiment, the first generation control corresponding to the language model and the corresponding first configuration area are displayed on the dashboard creation page. Therefore, a dashboard construction capability based on the language model can be provided. Then, the first construction information is configured through the configuration operation for the first configuration item in the first configuration area. The language model automatically identifies key metadata in the first construction information and constructs a draft of the dashboard. Therefore, a construction idea of the dashboard may be described in natural language, to implement rapid construction of the data dashboard, thereby reducing the time required to generate the data dashboard. In addition, a blank drawing board may be prevented from appearing on the dashboard display page.

In some optional implementations, the dashboard display page is further used to display an analysis panel, where analysis content of the language model for the first dashboard is displayed in the analysis panel, and the analysis content includes at least one selected from the group consisting of a generation progress of the first dashboard, an analysis objective of the first dashboard, an analysis process of the first dashboard, a layout status of the first dashboard, and a generation status of the first chart.

For example, the generation status of the first chart includes a detailed table of the generated first chart and a generation completion status of the entire first chart.

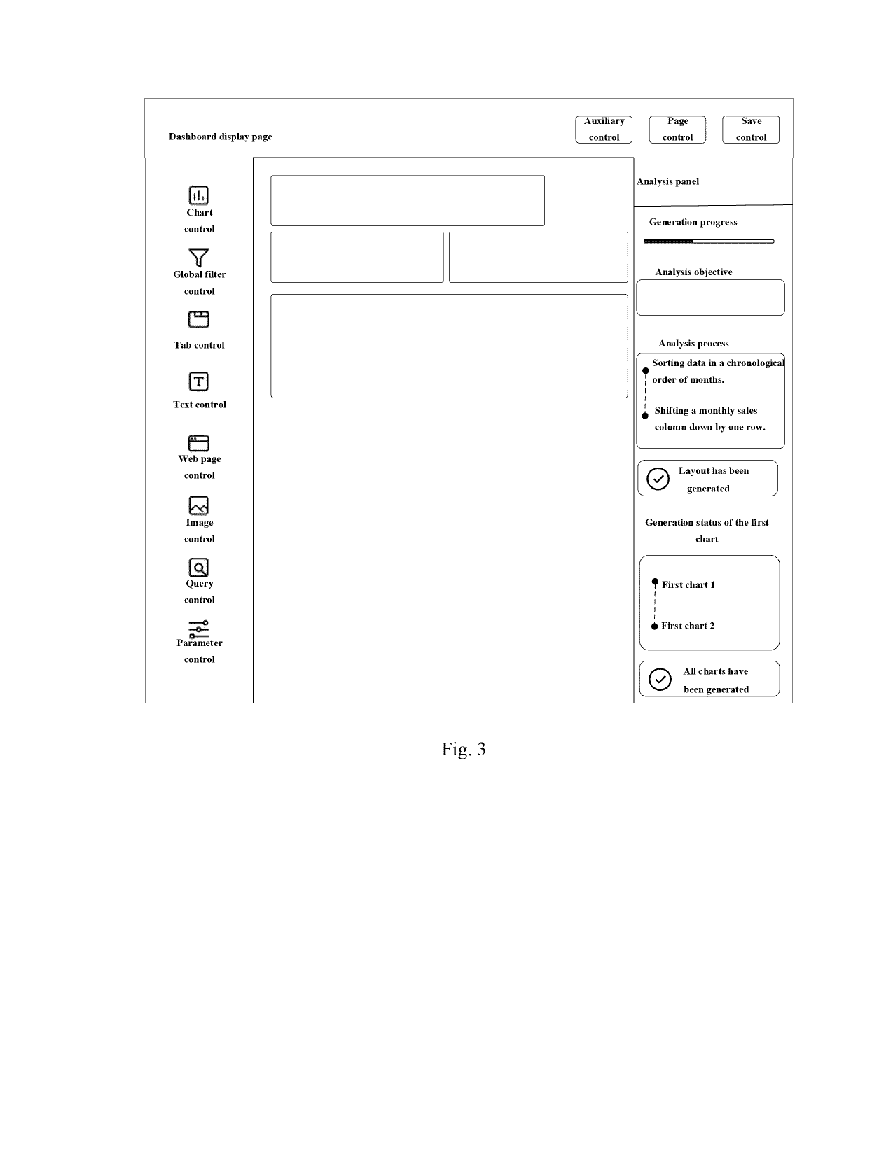

Exemplarily, as shown in FIG. 3, in a process in which the first dashboard is generated by the language model, the analysis panel may further be displayed on the dashboard display page. The analysis content of the language model for the first dashboard, for example, the generation progress of the first dashboard, the analysis objective of the first dashboard, the analysis process of the first dashboard, the layout status of the first dashboard, and the generation status of the first chart, are displayed in the analysis panel. In the analysis panel shown in FIG. 3, the analysis process of the first dashboard is "first, sorting data in a chronological order of months, and then, shifting a monthly sales column down by one row", the layout status of the first dashboard has been generated, the first chart 1 and the first chart 2 have been generated, and all the charts have been generated.

Furthermore, in the process in which the first dashboard is generated by the language model, a stop control is further displayed in the analysis panel, and generation of the first dashboard may be stopped in response to an interaction operation for the stop control. Furthermore, after the first dashboard is completely generated or the generation is stopped, a regeneration control is further displayed in the analysis panel. The first dashboard may be regenerated in response to an interaction operation for the regeneration control. Therefore, the user can terminate the generation process of the first dashboard and re-initiate a new dashboard construction process.

It should be noted that in the process of generating the first dashboard, a skeleton screen being loaded (a frame shown in the middle of FIG. 3) may be displayed on the dashboard display page, to improve user experience.

According to the method for generating a data dashboard provided in this embodiment, the analysis content of the language model for the first dashboard is displayed in the analysis panel. Therefore, transparency of the first dashboard may be improved, to facilitate better understanding of a source, a processing method, and analysis logic of the first dashboard, thereby enabling in-depth understanding of information conveyed by the first dashboard.

In some optional implementations, the method for generating a data dashboard in the present disclosure further includes: displaying at least one function control corresponding to the first chart in response to an interaction operation for the first chart, where the function control is used to trigger processing for performing a corresponding function on the first chart.

Optionally, the function control includes at least one selected from the group consisting of a configuration control, an analysis control, a search control, and a beautification control. It should be noted that the above function control is only an example, and may be adjusted based on an actual situation.

For example, a first toolbar is displayed in response to the interaction operation for the first chart, and the at least one function control is displayed on the first toolbar. Therefore, a global function that is provided by the language model for the first chart may be integrated with the first toolbar, to avoid frequent searching for the function control of the language model.

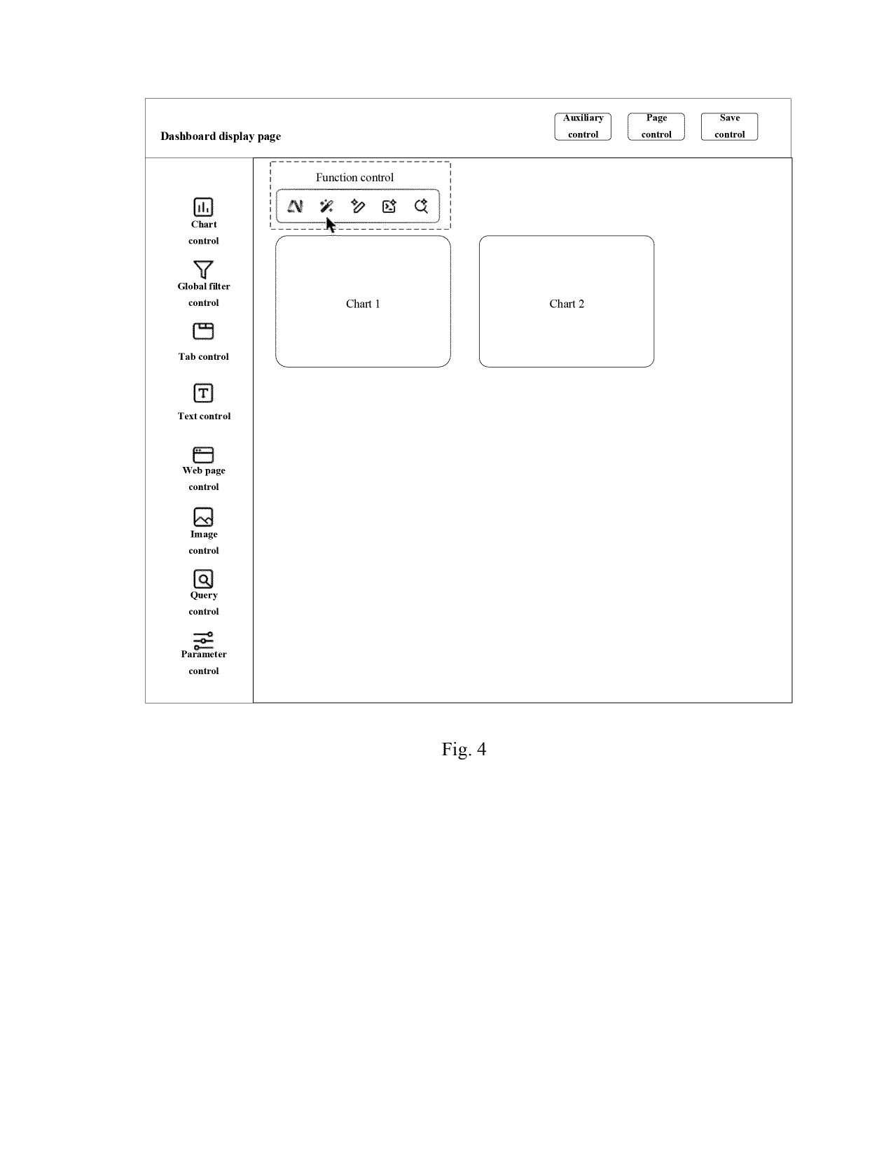

Exemplarily, as shown in FIG. 4, it is assumed that the first chart includes a chart 1 and a chart 2. If the chart 1 needs to be edited, the chart 1 may be clicked to display a function control for the chart 1, and the function control is used to process the chart 1.

According to the method for generating a data dashboard provided in this embodiment, when the first chart is interacted with, the first function control is provided to trigger the processing for performing the corresponding function on the first chart. Therefore, the capability provided by the first function control may be used to improve chart editing efficiency, to further improve the editing efficiency of the data dashboard.

In some optional implementations, the function control includes a configuration control. The method for generating a data dashboard in the present disclosure further includes: displaying a configuration page in response to an interaction operation for the configuration control, where at least one configuration field of the first chart is displayed on the configuration page; obtaining a target field value of the configuration field in response to a field value interaction operation for the configuration field; and adjusting the first chart based on the target field value of the configuration field to obtain the updated first chart.

Optionally, the configuration field includes at least one selected from the group consisting of a dimension, an indicator, a chart type, and a filter condition.

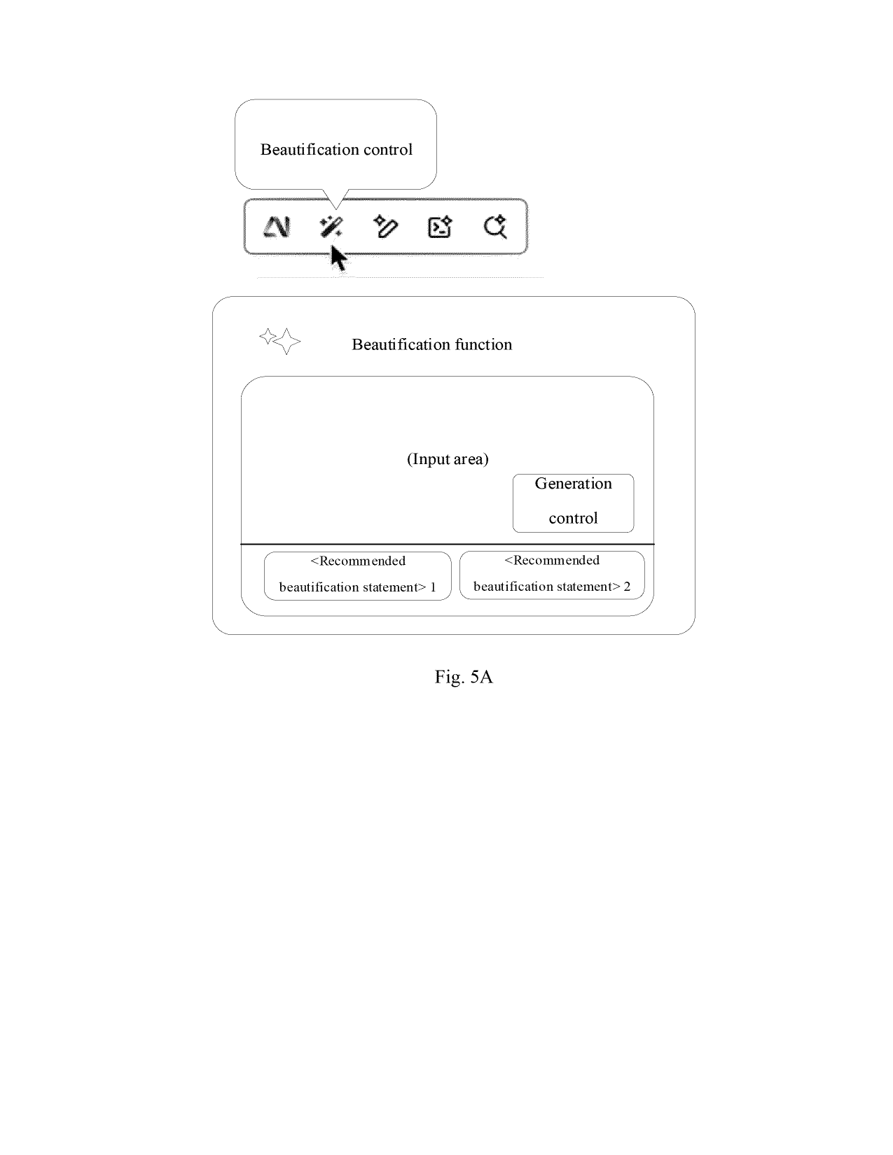

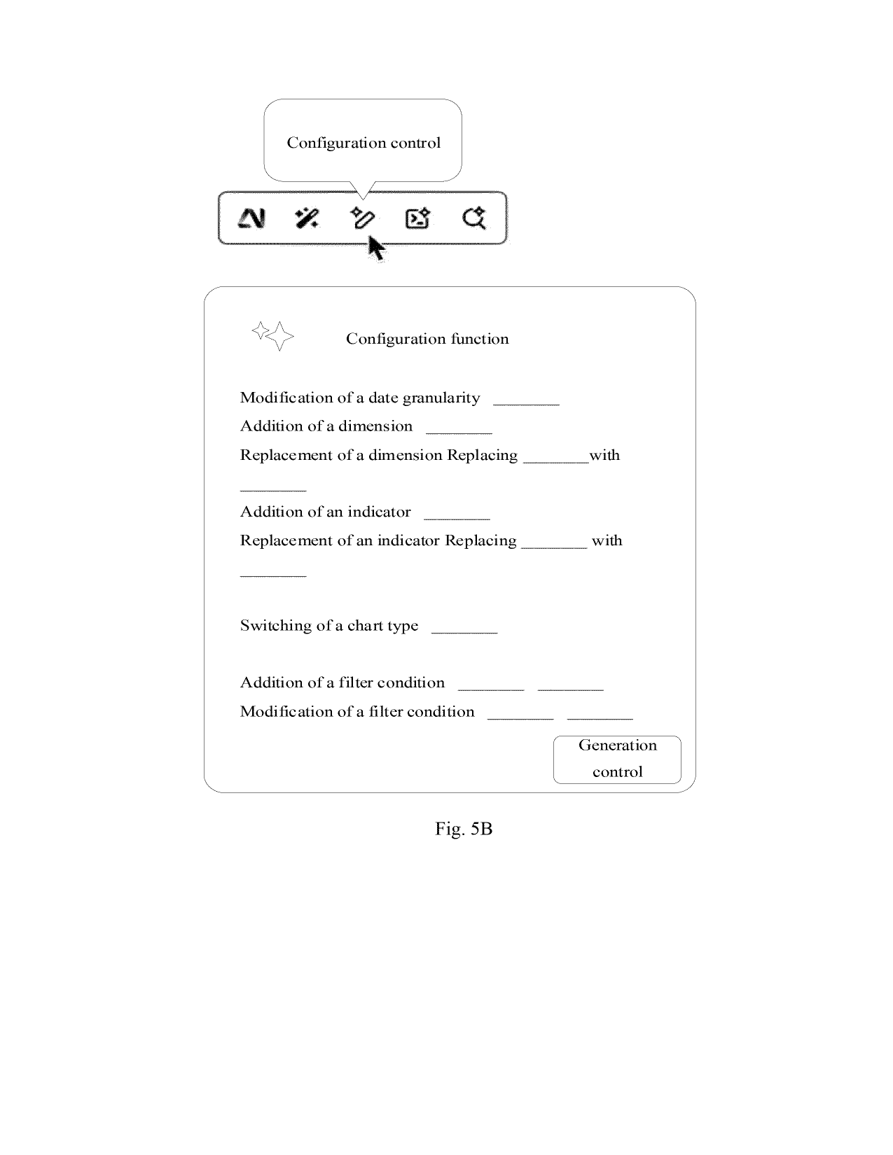

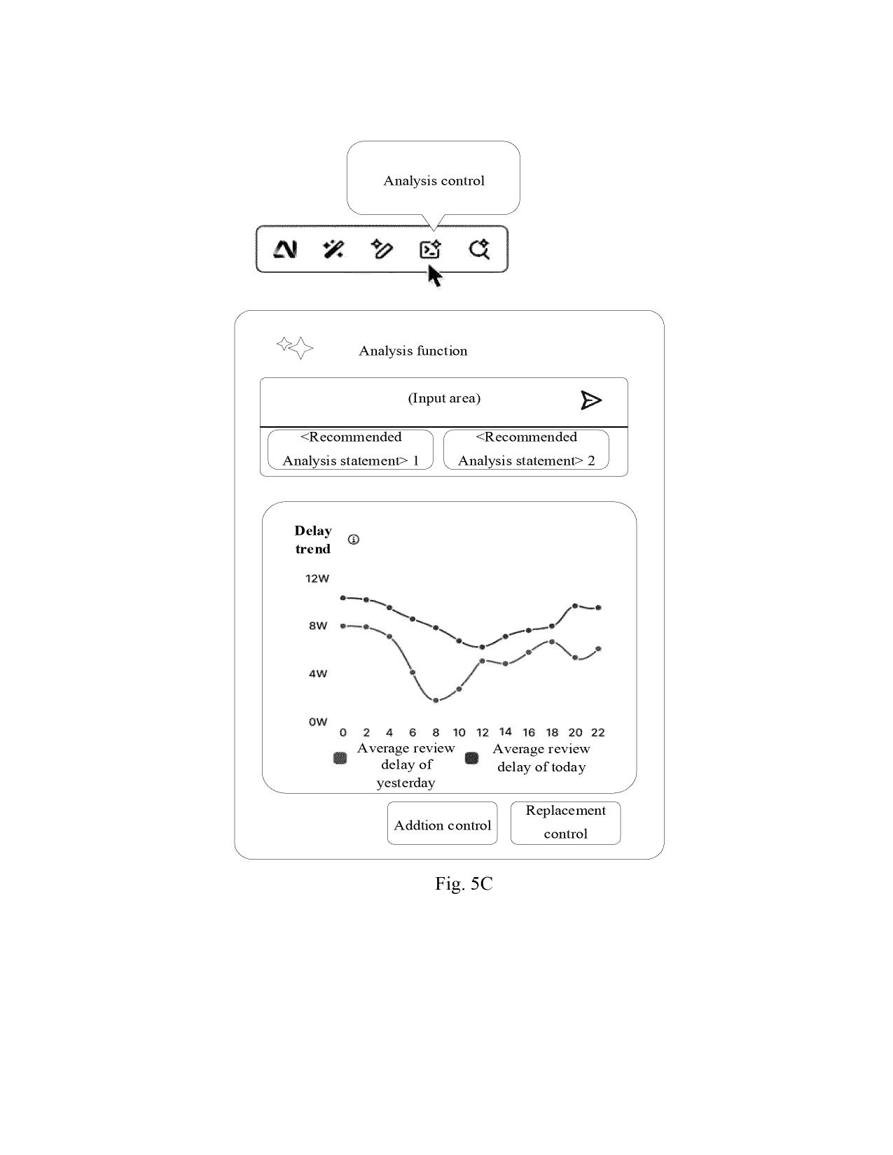

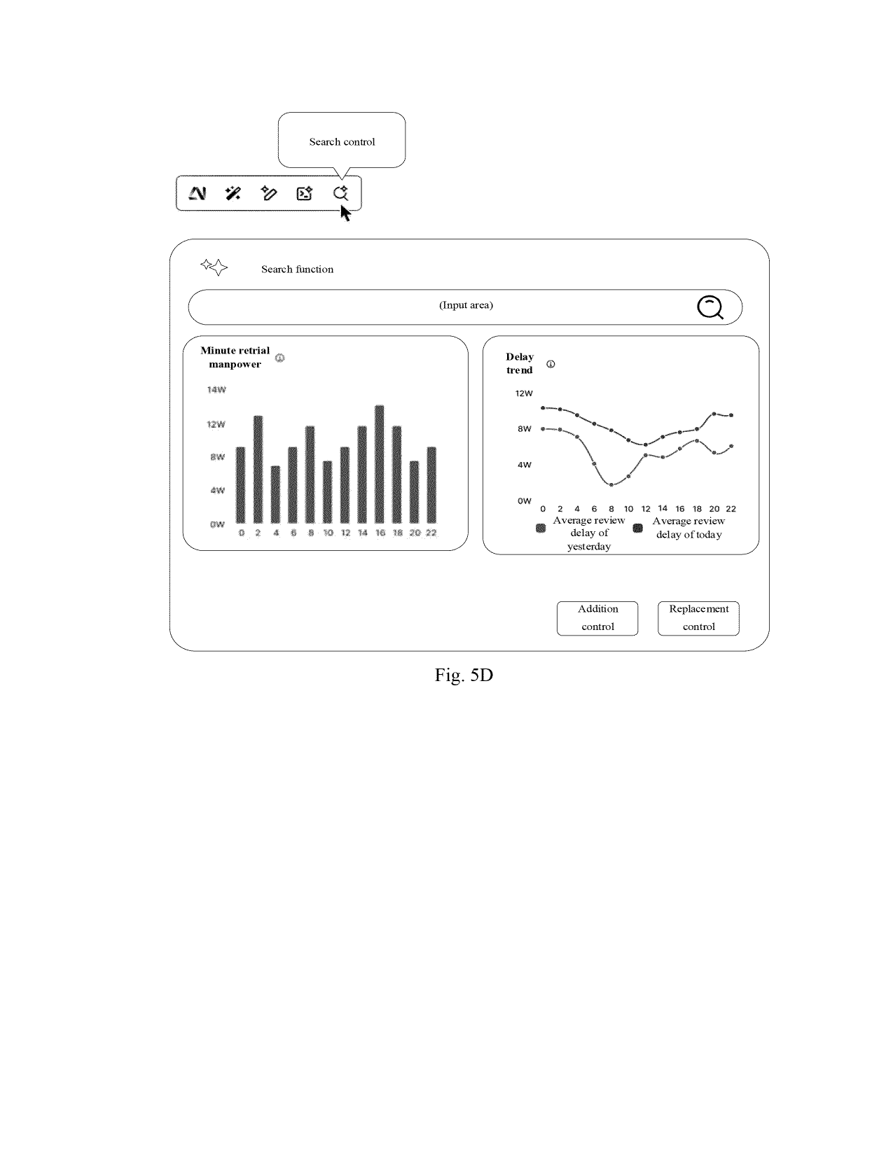

Exemplarily, as shown in FIG. 5B, the configuration field of the dimension includes modification of a date granularity, addition of a dimension, replacement of a dimension, and the like. The indicator includes addition of an indicator, replacement of an indicator, and the like. The configuration field of the chart type includes switching of a chart type, and the like. The configuration field of the filter condition includes addition of a filter condition, modification of a filter condition, and the like. It should be noted that the above configuration field is only an example, and may be adjusted based on an actual situation.

According to the method for generating a data dashboard provided in this embodiment, the configuration control is provided to adjust the configuration field. Therefore, the configuration page may be called up with the configuration control without a visual query page, to quickly adjust the configuration field, thereby updating the first chart, and reducing jumps of the visual page at the same time.

In some optional implementations, the function control includes an analysis control. The method for generating a data dashboard in the present disclosure further includes: displaying an analysis page in response to an interaction operation for the analysis control; and analyzing the first chart in response to first content input in the analysis page to obtain an analysis result of the first chart.

Furthermore, at least one optional analysis statement, for example, an optional analysis statement 1 and an optional analysis statement 2, is further displayed on the analysis page. The first content input in the analysis page is determined in response to a selection operation for a target optional analysis statement in the at least one optional analysis statement. The first chart is analyzed based on the first content to obtain the analysis result of the first chart, for example, the "delay trend chart" shown in FIG. 5C.

Furthermore, an addition control and a replacement control are further displayed on the analysis page. After the analysis result of the first chart is obtained, the analysis result of the first chart may be added to the first dashboard in response to an interaction operation for the addition control. Alternatively, the corresponding first chart in the first dashboard is replaced in response to an interaction operation for the replacement control.

According to the method for generating a data dashboard provided in this embodiment, the analysis control is provided, and the analysis control is used to trigger the analysis function for the first chart. Therefore, the first chart may be re-analyzed through the analysis control, to perform data drilling on the first chart, thereby exploring a data rule represented by the first chart more deeply.

In some optional implementations, the function control includes a search control. The method for generating a data dashboard in the present disclosure further includes: displaying a search page in response to an interaction operation for the search control; and performing the search to obtain a second chart related to the first chart in response to second content input in the search page.

For example, the second content is input through an input control on the search page, to search for the second chart related to the first chart.

For example, the second chart related to the first chart is searched for in a chart generated based on the dataset corresponding to the first chart. For example, the "minute retrial manpower chart" and the "delay trend chart" shown in FIG. 5D.

Furthermore, an addition control and a replacement control are further displayed on the search page. After the second chart is searched for, the selected second chart is determined in response to a selection operation for the second chart. The selected second chart is added to the first dashboard in response to an interaction operation for the addition control. Alternatively, the corresponding first chart in the first dashboard is replaced with the selected second chart in response to an interaction operation for the replacement control.

According to the method for generating a data dashboard provided in this embodiment, the search control is provided, and the search control is used to trigger the chart search function. Therefore, a chart related to the first chart may be searched for through the search control, to further improve the efficiency of building the data dashboard.

In some optional implementations, the function control includes a beautification control. The method for generating a data dashboard in the present disclosure further includes: displaying an editing page in response to an interaction operation for the beautification control; and performing a beautification operation on the first chart in response to third content input in the editing page to obtain the updated first chart.

For example, as shown in FIG. 5A, at least one recommended beautification statement, for example, a recommended beautification statement 1 and a recommended beautification statement 2, is displayed on the editing page. The method for generating a data dashboard in the present disclosure further includes: determining the third content in response to a selection operation for a target recommended beautification statement in the at least one recommended beautification statement; and performing the beautification operation on the first chart based on the third content to obtain the updated first chart.

According to the method for generating a data dashboard provided in this embodiment, the beautification control is provided, and the beautification control is used to trigger the beautification function for the first chart. Therefore, the beautification operation may be performed on the first chart through natural language input without adjusting display parameters, to quickly beautify the first chart.

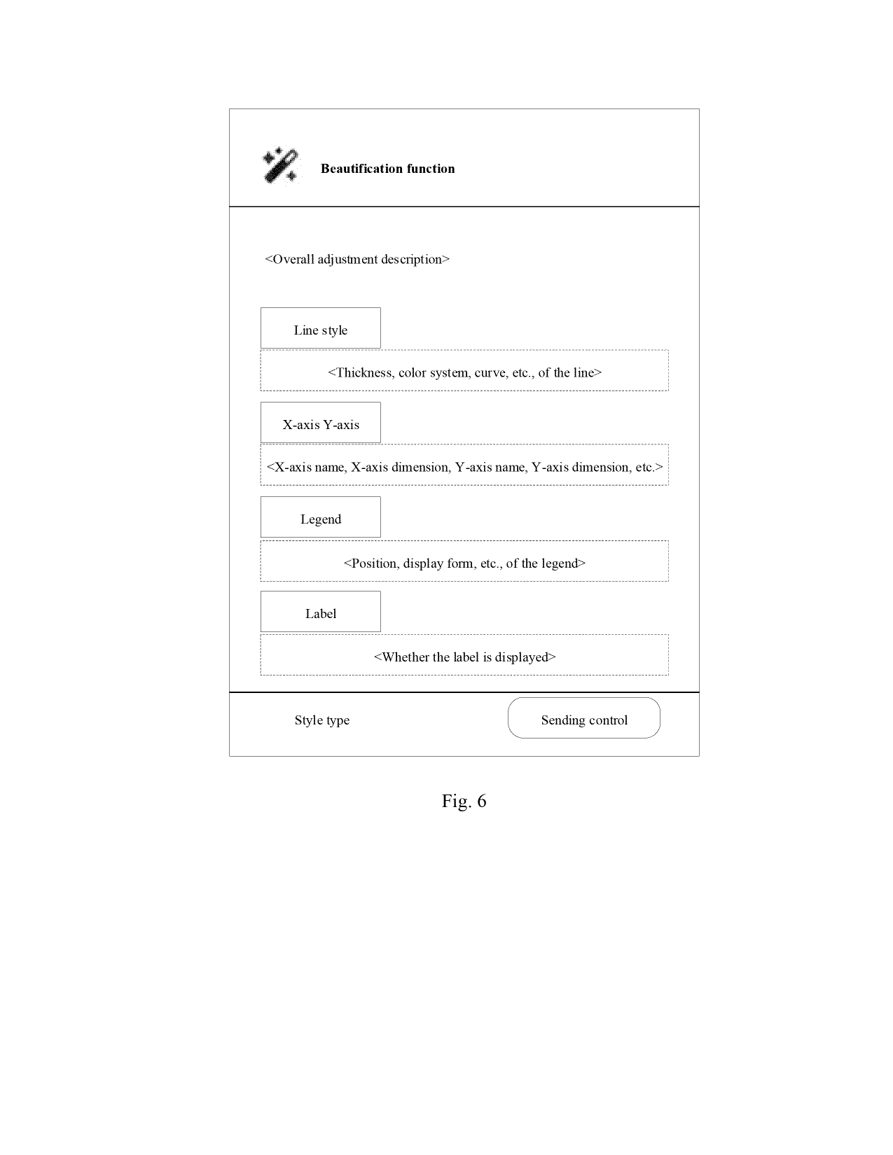

In some other optional implementations, as shown in FIG. 6, the method for generating a data dashboard in the present disclosure further includes: displaying an editing page in response to an interaction operation for the beautification control, where at least one display style of the first chart is displayed on the editing page; obtaining a target display style in response to a configuration operation for the at least one display style; and performing a beautification operation on the first chart based on the target display style to obtain the updated first chart.

Optionally, the display style includes at least one selected from the group consisting of a line style, an x-axis style, a y-axis style, a legend style, and a label style. It should be noted that the above display style is only an example, and may be adjusted based on an actual situation.

Furthermore, an overall adjustment description for the first chart may also be input in an input box on the editing page in natural language, and the beautification operation is performed on the first chart based on the overall adjustment description.

Exemplarily, as shown in FIG. 6, a description of the line style, such as a thickness, a color system, and a curve, of the line may be input in natural language, and a description of the x-axis style and the y-axis style, such as an x-axis name, an x-axis dimension, a y-axis name, and a y-axis dimension, may be input in natural language. Furthermore, a description of the legend style, such as a position and a display form of the legend, may be input in natural language, and a description of the label style of whether the label is displayed may be input in natural language. Furthermore, a sending control is displayed on the editing page of the beautification control. The beautification operation is performed on the first chart in response to an interaction operation for the sending control.

In some optional implementations, a chart control is further displayed on the dashboard display page. The method for generating a data dashboard in the present disclosure further includes: adding a chart container to the first dashboard in response to interaction information for the chart control, where the chart container includes a second generation control and a corresponding input control, and the second generation control corresponds to the language model; obtaining a target chart parameter in response to a chart parameter input based on the input control; and adding and displaying a third chart in the chart container in response to an interaction operation for the second generation control, where the third chart is generated by the language model based on the target chart parameter.

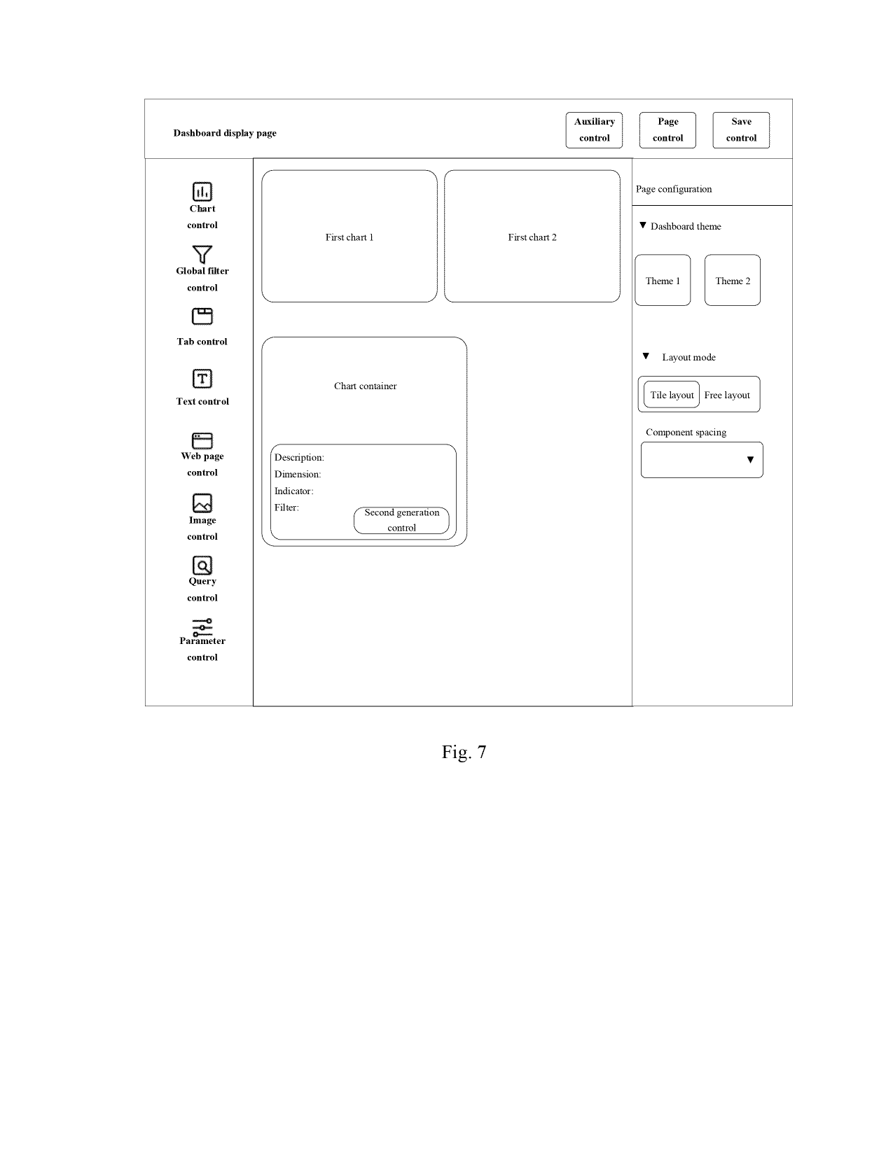

Exemplarily, as shown in FIG. 7, a toolbar is displayed on the dashboard display page, and at least one editing control is displayed in the toolbar. The editing control includes an editing control such as the chart control, a global filter control, a query control, a parameter control, an insertion control, a layer control, and an element control of an element other than the chart. The element control includes a tab control, a text control, a web page control, an image control, or another element control. This is not limited herein. The global filter control is used to globally filter elements of each dashboard on the dashboard display page. The query control is used to query the elements of each dashboard on the dashboard display page. The parameter control is used to adjust dynamic parameters involved in each dashboard on the dashboard display page. The insertion control is used to insert an insertion into the dashboard display page. The layer control is used to adjust a layer of the elements of each dashboard on the dashboard display page. It should be noted that the above editing control is only an example, and in actual operation, the editing control may be adjusted based on an actual situation.

Exemplarily, as shown in FIG. 7, the chart container is added to the first dashboard in response to the interaction information for the chart control, and the chart container includes the second generation control and the corresponding input control. The user may input a chart parameter, for example, a description, a dimension, an indicator, and a filter condition, in the input control in natural language. Then, the second generation control is interacted with, and the input target chart parameter is analyzed by the language model. The third chart is added and displayed in the chart container.

According to the method for generating a data dashboard provided in this embodiment, the chart control is provided to add the new chart container during the construction process. The chart parameter is input in the input control of the chart container to trigger the language model to analyze the input chart parameter, to generate the chart. Therefore, the chart can be independently generated by the language model, to provide a choice of a plurality of chart generation manners.

In some optional implementations, an auxiliary control is further displayed on the dashboard display page, and the auxiliary control is used to trigger display of at least one construction function provided by the language model.

Optionally, the construction function includes at least one selected from the group consisting of a creation function, a layout function, and a beautification function. The creation function may be further divided into a first creation function for creating a dashboard through a dataset and a second creation function for creating a dashboard through a chart. It should be noted that the above construction function is only an example, and may be adjusted based on an actual situation.

According to the method for generating a data dashboard provided in this embodiment, the auxiliary control is used to integrate the construction function provided by the language model, to provide a unified entry for using the construction function provided by the language model. Therefore, the efficiency of building the dashboard may be further improved.

In some optional implementations, the method for generating a data dashboard in the present disclosure further includes: displaying at least one construction function on an auxiliary page in response to an interaction operation for the auxiliary control; and triggering processing of a target construction function in response to a selection operation for the target construction function in the at least one construction function.

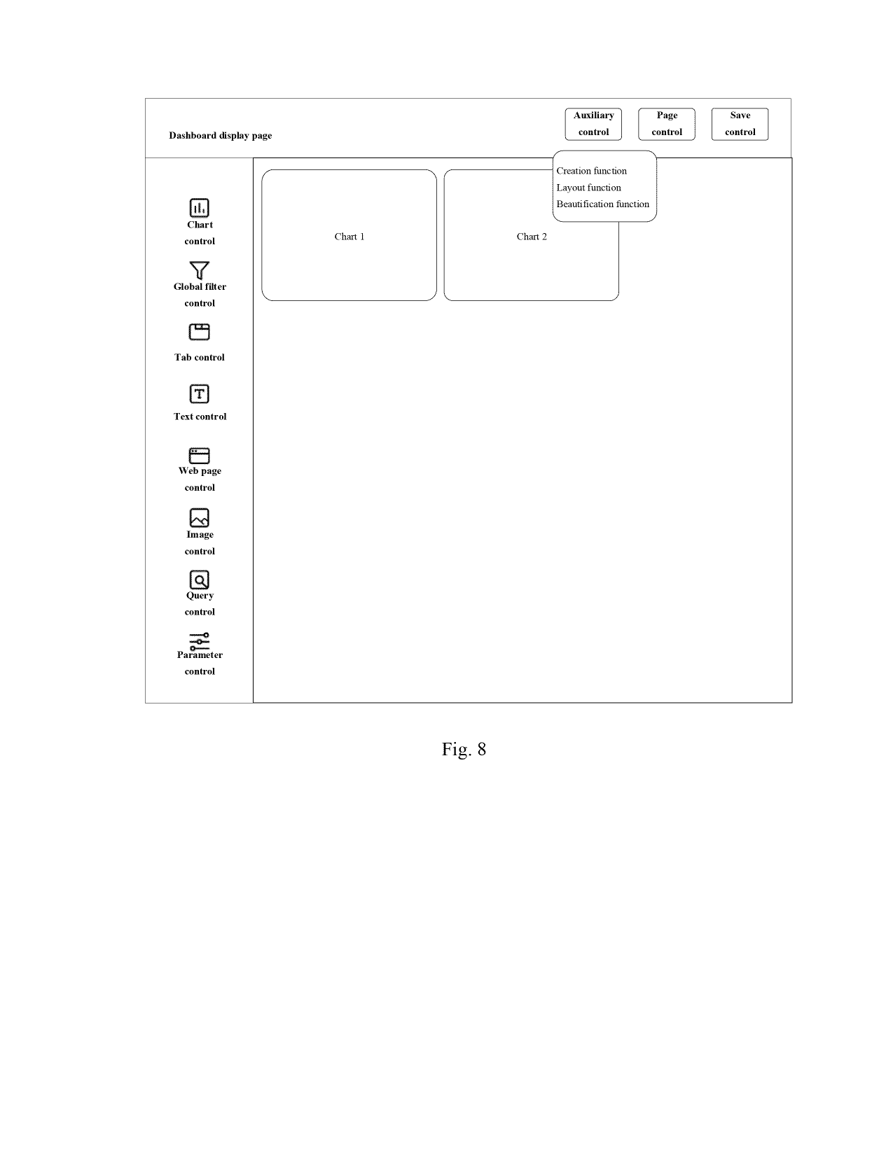

Exemplarily, as shown in FIG. 8, in response to the interaction operation for the auxiliary control, the construction functions such as the creation function, the layout function, and the beautification function are displayed on the auxiliary page. The processing information of the selected construction function may be directly input on the auxiliary page. Alternatively, a processing page of the selected construction function may be displayed to configure the processing information of the selected construction function.

According to the method for generating a data dashboard provided in this embodiment, the at least one construction function is displayed on the auxiliary page, and the processing of the corresponding construction function is triggered by selecting the construction function. Therefore, the dashboard on the dashboard display page may be quickly adjusted and updated by using the construction function provided by the language model.

In some optional implementations, the at least one construction function includes a first creation function for creating a dashboard through a dataset; and triggering the processing of the target construction function in response to the selection operation for the target construction function in the at least one construction function includes: displaying a second configuration area in response to a selection operation for the first creation function, where the second configuration area includes a second configuration item of at least one second construction parameter, and the second construction parameter includes the dataset; obtaining second construction information in response to a configuration operation for the second configuration item; and adding and displaying a second dashboard on the dashboard display page in response to the second construction information, where the second dashboard is generated by the language model based on the second construction information.

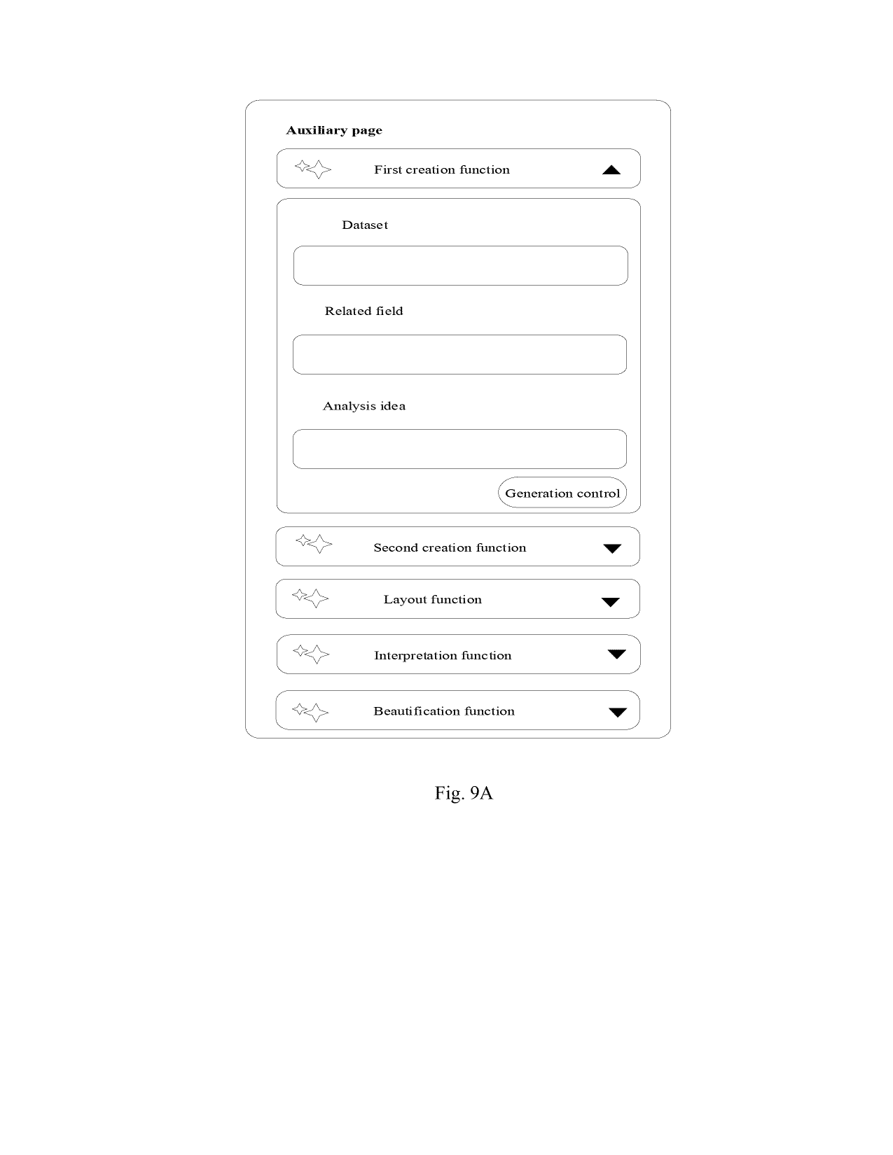

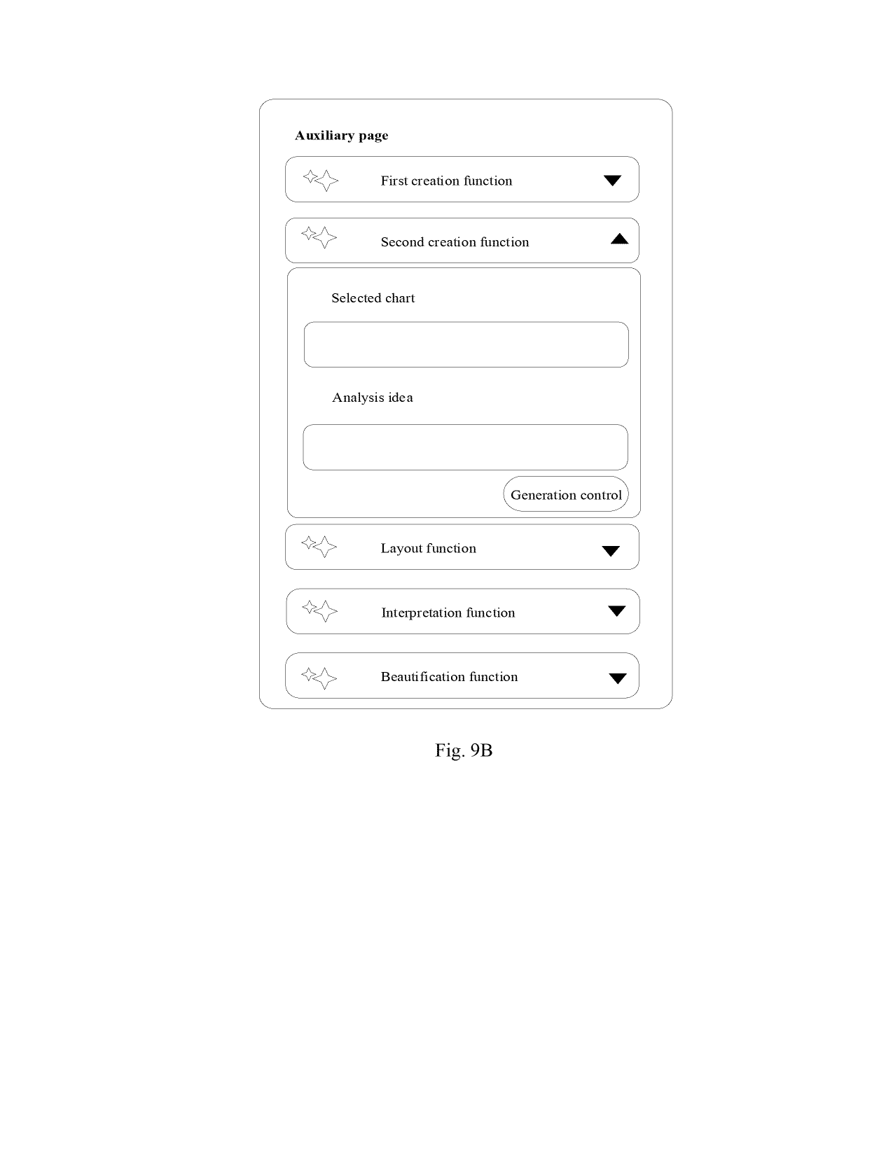

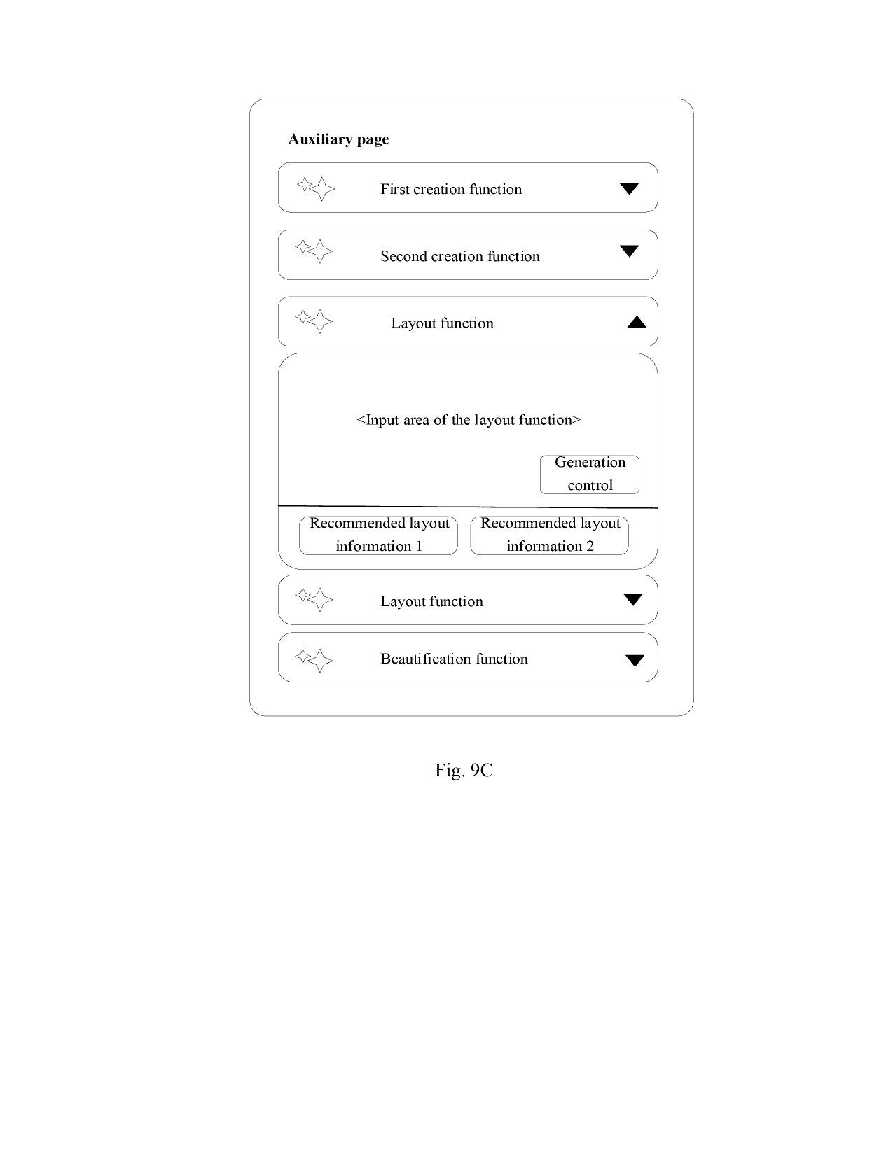

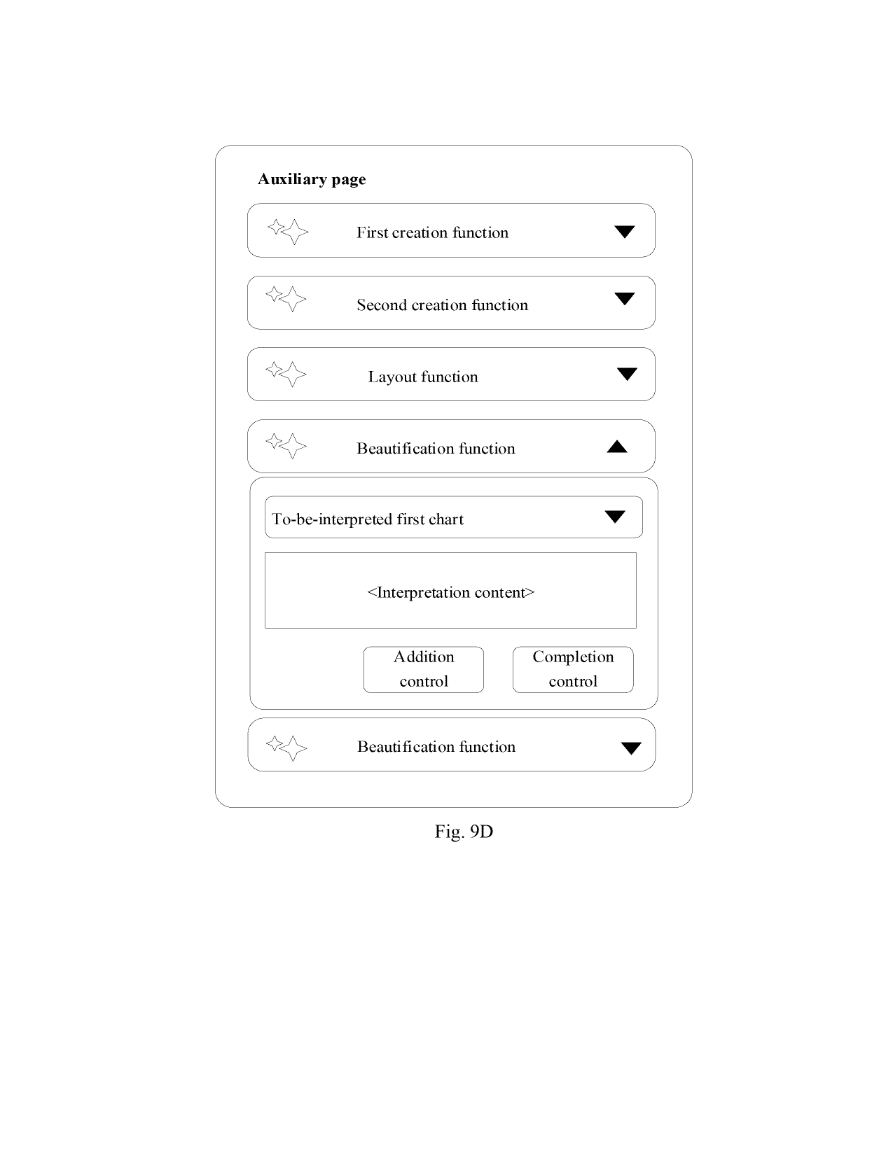

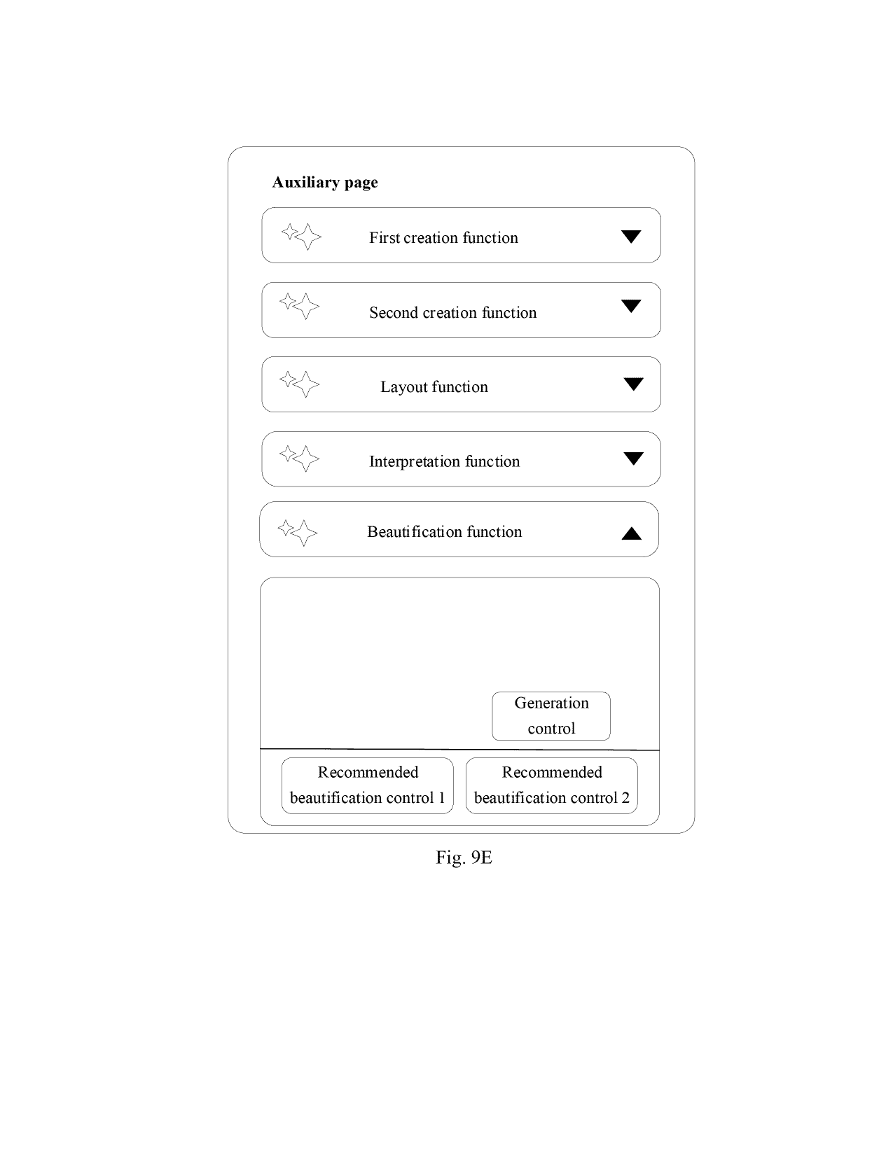

Optionally, as shown in FIG. 9A, the second construction parameter includes at least one selected from the group consisting of a dataset, a related field, and an analysis idea. It should be noted that the above second construction parameter is only an example, and may be adjusted based on an actual situation.

According to the method for generating a data dashboard provided in this embodiment, the first creation function for creating the dashboard through the dataset is provided. Therefore, the language model may be used to analyze the selected dataset, to quickly construct a new dashboard.

In some optional implementations, the at least one construction function includes a second creation function for creating a dashboard through a chart; and triggering the processing of the target construction function in response to the selection operation for the target construction function in the at least one construction function includes: displaying a third configuration area in response to a selection operation for the second creation function, where the third configuration area includes a third configuration item of at least one third construction parameter, and the third construction parameter includes a selected chart; obtaining third construction information in response to a configuration operation for the third configuration item; and adding and displaying a third dashboard on the dashboard display page in response to the third construction information, where the third dashboard is generated by the language model based on the third construction information.

Optionally, as shown in FIG. 9B, the third construction parameter includes at least one selected from the group consisting of the selected chart and an analysis idea. It should be noted that the above third construction parameter is only an example, and may be adjusted based on an actual situation.

According to the method for generating a data dashboard provided in this embodiment, the second creation function for creating the dashboard through the chart is provided. Therefore, the language model and the created chart may be used to quickly construct a new dashboard.

In some optional implementations, the at least one construction function includes a layout function; and triggering the processing of the target construction function in response to the selection operation for the target construction function in the at least one construction function includes: displaying a fourth configuration area in response to a selection operation for the layout function; and adjusting a layout status of the first dashboard in response to layout information input in the fourth configuration area to obtain the updated first dashboard.

Optionally, as shown in FIG. 9C, an input control is displayed in the fourth configuration area, and the layout information may be input through the input control. Furthermore, a generation control is displayed in the fourth configuration area, and the language model may be triggered, through interaction with the generation control, to adjust the layout status of the first dashboard based on the layout information.

It should be noted that if a plurality of dashboards, such as the first dashboard, the second dashboard, and the third dashboard, are displayed on the dashboard display page, the layout function may also be used to adjust the layout status of the second dashboard and the third dashboard. This is not limited herein.

According to the method for generating a data dashboard provided in this embodiment, the layout function is provided to input the layout information in natural language, and then the language model is used to adjust the layout status of the dashboard. Therefore, the efficiency of adjusting the layout status of the data dashboard can be effectively improved.

In some optional implementations, at least one optional layout mode and/or at least one piece of recommended layout information are displayed in the fourth configuration area.

Exemplarily, as shown in FIG. 9C, at least one piece of recommended layout information is displayed in the fourth configuration area. Target layout information may be determined in response to a selection operation for target recommended layout information in the at least one piece of recommended layout information, and the first dashboard is adjusted based on the target layout information.

Alternatively, at least one optional layout mode is displayed in the fourth configuration area. The target layout information may be determined in response to a selection operation for a target optional layout mode in the at least one optional layout mode, and the first dashboard is adjusted based on the target layout information.

According to the method for generating a data dashboard provided in this embodiment, the at least one optional layout mode and/or the at least one piece of recommended layout information are provided for selection. Therefore, the efficiency of adjusting the layout status of the data dashboard can be further improved.

In some other optional implementations, the at least one construction function includes a layout function; and triggering the processing of the target construction function in response to the selection operation for the target construction function in the at least one construction function includes: displaying a processing page corresponding to the layout function in response to a selection operation for the layout function; and adjusting a layout status of the first dashboard in response to layout information input in the processing page corresponding to the layout function to obtain the updated first dashboard.

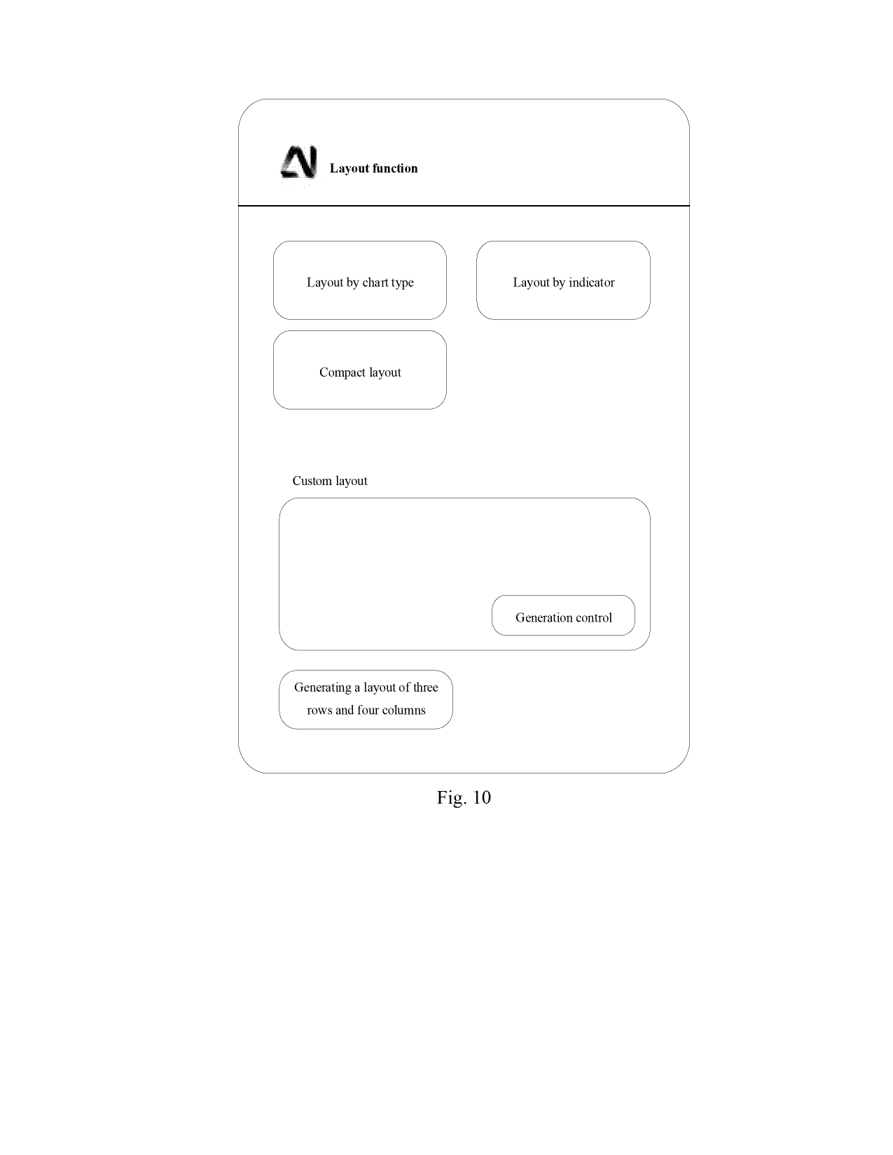

Exemplarily, as shown in FIG. 10, three optional layout modes, namely, layout by chart type, layout by indication, and compact layout, are displayed on the processing page of the layout function. Furthermore, one piece of recommended layout information "Generating a layout of three rows and four columns" is displayed. The layout information input in the processing page corresponding to the layout function may be determined by selecting the optional layout mode or the recommended layout information, to adjust the first dashboard. Alternatively, the layout information is input in natural language in an input control of custom layout, and in response to an interaction operation for a generation control on the processing page, the input layout information is analyzed by the language model, to adjust the first dashboard to obtain the updated first dashboard.

In some optional implementations, the at least one construction function includes an interpretation function; and triggering the processing of the target construction function in response to the selection operation for the target construction function in the at least one construction function includes: displaying a fifth configuration area in response to a selection operation for the interpretation function; and obtaining interpretation content of a to-be-interpreted first chart in response to the to-be-interpreted first chart that is input in the fifth configuration area.

Exemplarily, as shown in FIG. 9D, the to-be-interpreted first chart may be configured in the fifth configuration area, and then the to-be-interpreted first chart is interpreted by the language model, to obtain the interpretation content of the first chart. Furthermore, an addition control and a completion control are displayed in the fifth configuration area. If the addition control is interacted with, the interpretation content is added to the first dashboard. If the completion control is interacted with, this interpretation process ends.

According to the method for generating a data dashboard provided in this embodiment, the interpretation function is provided to interpret the to-be-interpreted first chart. Therefore, the to-be-interpreted first chart CAN be deeply explored, to drill down data information represented by the first chart.

In some optional implementations, the at least one construction function further includes a beautification function. Triggering the processing of the target construction function in response to the selection operation for the target construction function in the at least one construction function includes: displaying a sixth configuration area in response to a selection operation for the beautification function; and performing a beautification operation on the first dashboard in response to beautification information input in the sixth configuration area, to obtain the updated first dashboard, as shown in FIG. 9E.

It should be noted that for the related process of the beautification function, reference may be made to the related process of the beautification control. Details are not described herein again.

It should be noted that in an actual processing process, an accordion panel may be used to be compatible with and expand the construction function provided by the language model, to provide more construction functions for the dashboard.

In some optional implementations, a save control is further displayed on the dashboard display page, and the save control is used to save the dashboard on the dashboard display page.

As a specific application example, a target application is installed on the electronic device, and the target application is used to generate a data dashboard. The method for generating a data dashboard in the present disclosure may be used in the target application to provide various dashboard construction functions and function controls in combination with the language model, to quickly construct a data dashboard by using data processing technologies, artificial intelligence technologies, large model technologies, and large language model technologies, thereby effectively improving the efficiency of building the data dashboard and reducing the time required to generate the data dashboard.

In this embodiment, an apparatus for generating a data dashboard is further provided. The apparatus is configured to implement the above embodiments and preferred implementations, which will not be repeated here. As used below, the term "module" may implement a combination of software and/or hardware for a predetermined function. Although the apparatus described in the following embodiments is preferably implemented in software, implementation in hardware, or a combination of software and hardware is also possible and contemplated.

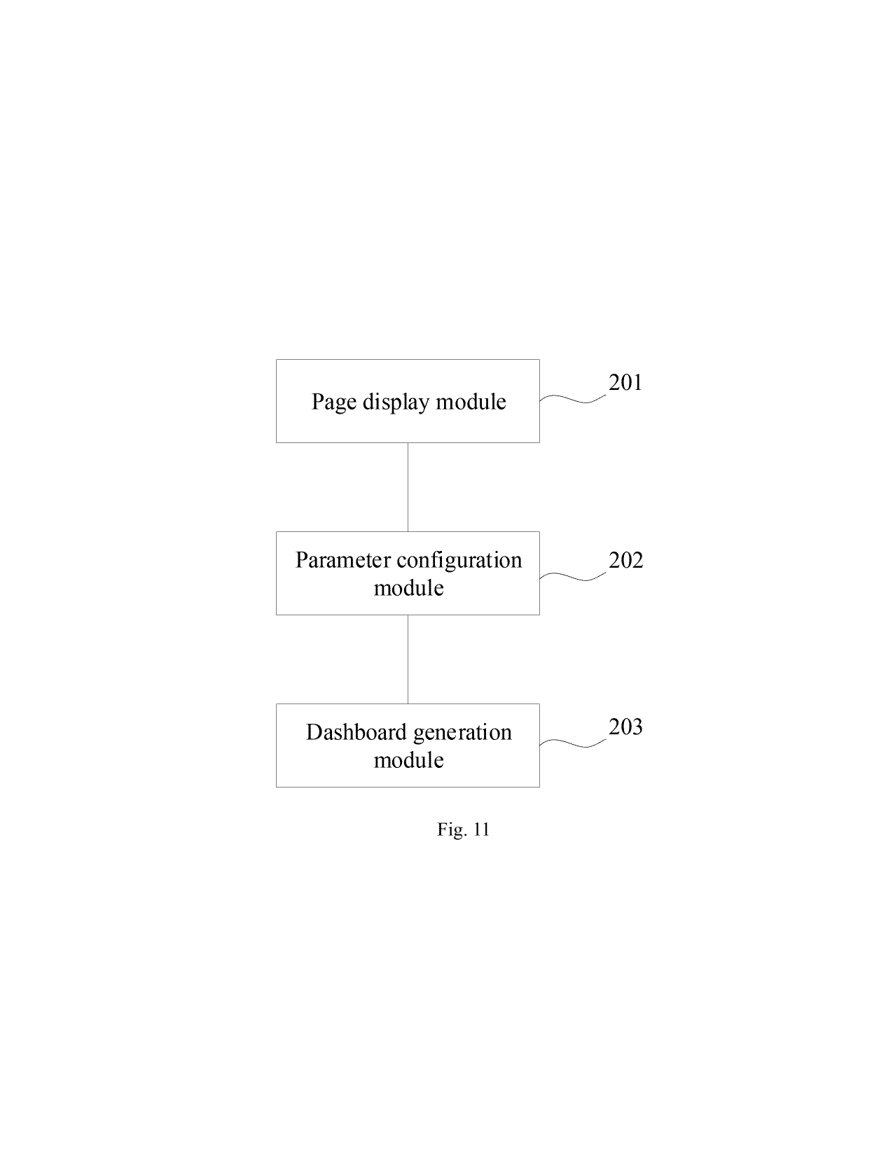

This embodiment provides an apparatus for generating a data dashboard. As shown in FIG. 11, the apparatus includes:

a page display module 201, configured to display a dashboard creation page, where the dashboard creation page is displayed with a first generation control and a corresponding first configuration area, the first generation control corresponds to a language model, and the first configuration area is provided with a first configuration item of at least one first construction parameter of a dashboard;

a parameter configuration module 202, configured to obtain first construction information in response to a configuration operation for the first configuration item; and

a dashboard generation module 203, configured to display a first dashboard on a dashboard display page in response to an interaction operation for the first generation control, where the first dashboard includes at least one first chart, and the first chart is generated by the language model based on the first construction information.

In some optional implementations, the dashboard display page is further used to display an analysis panel, where analysis content of a language model for the first dashboard is displayed in the analysis panel, and the analysis content includes at least one selected from the group consisting of a generation progress of the first dashboard, an analysis objective of the first dashboard, an analysis process of the first dashboard, a layout status of the first dashboard, and a generation status of the first chart.

In some optional implementations, the apparatus for generating a data dashboard in the present disclosure further includes:

a function control trigger module, configured to display at least one function control corresponding to the first chart in response to an interaction operation for the first chart, where the function control is used to trigger processing for performing a corresponding function on the first chart.

In some optional implementations, the function control includes a configuration control. The function control trigger module includes:

a configuration control trigger unit, configured to display a configuration page in response to an interaction operation for the configuration control, where at least one configuration field of the first chart is displayed on the configuration page;

a field value adjustment unit, configured to obtain a target field value of the configuration field in response to a field value interaction operation for the configuration field; and

a first update unit, configured to adjust the first chart based on the target field value of the configuration field to obtain an updated first chart.

In some optional implementations, the function control includes an analysis control. The function control trigger module includes:

an analysis control trigger unit, configured to display an analysis page in response to an interaction operation for the analysis control; and

a chart analysis unit, configured to analyze the first chart in response to first content input in the analysis page to obtain an analysis result of the first chart.

In some optional implementations, the function control includes a search control. The function control trigger module includes:

a search control trigger unit, configured to display a search page in response to an interaction operation for the search control; and

a chart search unit, configured to perform search to obtain a second chart related to the first chart in response to second content input in the search page.

In some optional implementations, the function control includes a beautification control. The function control trigger module includes:

a beautification control trigger unit, configured to display an editing page in response to an interaction operation for the beautification control; and

a chart beautification unit, configured to perform a beautification operation on the first chart in response to third content input in the editing page to obtain an updated first chart.

In some optional implementations, a chart control is further displayed on the dashboard display page. The apparatus for generating a data dashboard in the present disclosure further includes:

a container addition module, configured to add a chart container to the first dashboard in response to interaction information for the chart control, where the chart container includes a second generation control and a corresponding input control, and the second generation control corresponds to the language model;

a parameter input module, configured to obtain a target chart parameter in response to a chart parameter input based on the input control; and

a chart addition module, configured to add and display a third chart in the chart container in response to an interaction operation for the second generation control, where the third chart is generated by the language model based on the target chart parameter.

In some optional implementations, an auxiliary control is further displayed on the dashboard display page, and the auxiliary control is used to trigger display of at least one construction function provided by the language model.

In some optional implementations, the apparatus for generating a data dashboard in the present disclosure further includes:

an auxiliary control trigger module, configured to display the at least one construction function on an auxiliary page in response to an interaction operation for the auxiliary control; and

a construction function execution module, configured to trigger processing of a target construction function in response to a selection operation for the target construction function in the at least one construction function.

In some optional implementations, the at least one construction function includes a first creation function for creating a dashboard through a dataset. The construction function execution module includes:

a first function trigger unit, configured to display a second configuration area in response to a selection operation for the first creation function, where the second configuration area includes a second configuration item of at least one second construction parameter, and the second construction parameter includes the dataset;

a first parameter configuration unit, configured to obtain second construction information in response to a configuration operation for the second configuration item; and

a first dashboard creation unit, configured to add and display a second dashboard on the dashboard display page in response to the second construction information, where the second dashboard is generated by the language model based on the second construction information.

In some optional implementations, the at least one construction function includes a second creation function for creating a dashboard through a chart. The construction function execution module includes:

a second function trigger unit, configured to display a third configuration area in response to a selection operation for the second creation function, where the third configuration area includes a third configuration item of at least one third construction parameter, and the third construction parameter includes a selected chart;

a second parameter configuration unit, configured to obtain third construction information in response to a configuration operation for the third configuration item; and

a second dashboard creation unit, configured to add and display a third dashboard on the dashboard display page in response to the third construction information, where the third dashboard is generated by the language model based on the third construction information.

In some optional implementations, the at least one construction function includes a layout function. The construction function execution module includes:

a layout function trigger unit, configured to display a fourth configuration area in response to a selection operation for the layout function; and

a layout adjustment unit, configured to adjust a layout status of the first dashboard in response to layout information input in the fourth configuration area to obtain the updated first dashboard.

In some optional implementations, at least one optional layout mode and/or at least one piece of recommended layout information are displayed in the fourth configuration area.

In some optional implementations, the at least one construction function includes an interpretation function. The construction function execution module includes:

an interpretation function trigger unit, configured to display a fifth configuration area in response to a selection operation for the interpretation function; and

a chart interpretation unit, configured to obtain interpretation content of a to-be-interpreted first chart in response to the to-be-interpreted first chart that is input in the fifth configuration area.

Further function descriptions of the above modules and units are the same as those in the above corresponding embodiments, and details are not described herein again.

The apparatus for generating a data dashboard in this embodiment is presented in the form of a functional unit. Here, the unit is an ASIC (Application Specific Integrated Circuit) circuit, a processor and a memory that execute one or more pieces of software or a fixed program, and/or another device that may provide the above functions.

An embodiment of the present disclosure further provides an electronic device having the apparatus for generating a data dashboard shown in FIG. 11.

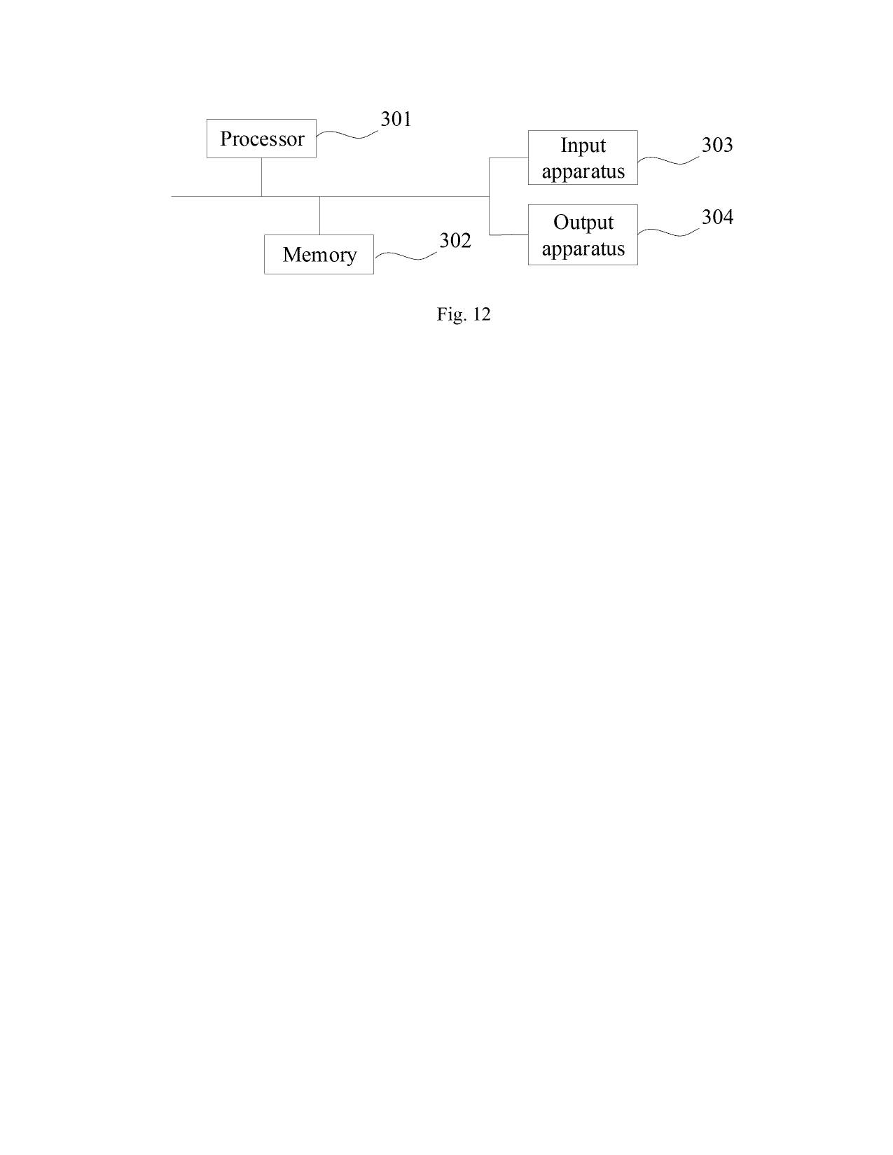

Referring to FIG. 12, FIG. 12 is a structural block diagram of an electronic device according to an optional embodiment of the present disclosure. As shown in FIG. 12, the electronic device includes: one or more processors 301, a memory 302, and interfaces for connecting various components, including high-speed interfaces and low-speed interfaces. The components communicate with each other using different buses, and may be installed on a common mainboard or in other manners as needed. The processor may process instructions executed within the electronic device, including instructions stored in or on the memory to display graphical information of GUI on an external input/output apparatus (such as a display device coupled to the interface). In some optional implementations, if required, multiple processors and/or buses may be used with multiple memories and multiple memories. Similarly, multiple electronic devices may be connected, and each device provides some necessary operations (for example, as a server array, a group of blade servers, or a multi-processor system). In FIG. 12, one processor 301 is used as an example.

The processor 301 may be a central processing unit, a network processor, or a combination thereof. Furthermore, the processor 301 may further include a hardware chip. The above hardware chip may be an application specific integrated circuit, a programmable logic device, or a combination thereof. The above programmable logic device may be a complex programmable logic device, a field programmable logic gate array, a generic array logic, or any combination thereof.

The memory 302 stores instructions executable by the at least one processor 301, so that the at least one processor 301 performs the method shown in the above embodiments.

The memory 302 may include a program storage area and a data storage area, where the program storage area may store an application program required by an operating system and at least one function; and the data storage area may store data created based on the use of the electronic device, and the like. Furthermore, the memory 302 may include a high-speed random access memory or a non-volatile memory, for example, at least one magnetic disk storage device, a flash memory device, or another non-volatile solid-state storage device. In some optional implementations, the memory 302 optionally includes memories remotely provided with respect to the processor 301, and these remote memories may be connected to the electronic device through a network. Examples of the above network include, but are not limited to, Internet, an intranet, a local area network, a mobile communication network, and a combination thereof.

The memory 302 may include a volatile memory, for example, a random access memory; the memory may also include a non-volatile memory, for example, a flash memory, a hard disk, or a solid-state disk; and the memory 302 may further include a combination of the above types of memories.

The electronic device further includes an input apparatus 303 and an output apparatus 304. The processor 301, the memory 302, the input apparatus 303, and the output apparatus 304 may be connected through a bus or in other manners. In FIG. 12, connection through a bus is used as an example.

The input apparatus 303 may receive input digital or character information, and generate a key signal input related to user settings and function control of the electronic device, for example, a touch screen, a keypad, a mouse, a track pad, a touch panel, an indicator stick, one or more mouse buttons, a trackball, a joystick, and the like. The output apparatus 304 may include a display device, an auxiliary lighting apparatus (for example, an LED), a tactile feedback apparatus (for example, a vibration motor), and the like. The above display device includes, but is not limited to, a liquid crystal display, a light emitting diode, a display, and a plasma display. In some optional implementations, the display device may be a touch screen.

An embodiment of the present disclosure further provides a computer-readable storage medium. The method according to the embodiments of the present disclosure may be implemented in hardware or firmware, or implemented as computer codes that may be recorded on a storage medium or originally stored in a remote storage medium or a non-transitory machine-readable storage medium and downloaded through a network and to be stored in a local storage medium. Therefore, the method described herein may be performed by such software stored on a storage medium using a general-purpose computer, a dedicated processor, or programmable or dedicated hardware. The storage medium may be a magnetic disk, an optical disc, a read-only memory, a random access memory, a flash memory, a hard disk, or a solid-state disk, and further, the storage medium may further include a combination of the above types of memories. It may be understood that the computer, the processor, the microprocessor controller, or the programmable hardware includes a storage component that may store or receive software or computer codes, and when the software or computer codes are accessed and executed by the computer, the processor, or the hardware, the method shown in the above embodiments is implemented.

A portion of the present disclosure may be applied as a computer program product, for example, computer program instructions that, when executed by a computer, may invoke or provide the method and/or the technical solutions according to the present disclosure through the operation of the computer. A person skilled in the art should understand that the computer program instructions exist in a computer-readable medium in a form including but not limited to a source file, an executable file, an installation package file, and the like. Correspondingly, the computer program instructions are executed by the computer in a manner including but not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure are described with reference to the drawings, a person skilled in the art may make various modifications and variations without departing from the spirit and scope of the present disclosure, and such modifications and variations fall within the scope defined by the appended claims.

1. A method for generating a data dashboard, comprising:
displaying a dashboard creation page, wherein a first generation control and a corresponding first configuration area are displayed on the dashboard creation page, the first generation control corresponds to a language model, and a first configuration item of at least one first construction parameter of a dashboard is provided in the first configuration area;
obtaining, in response to a configuration operation for the first configuration item, first construction information; and
displaying, in response to an interaction operation for the first generation control, a first dashboard on a dashboard display page, wherein the first dashboard comprises at least one first chart, and the at least one first chart is generated by the language model based on the first construction information.

2. The method for generating a data dashboard of claim 1, wherein the dashboard display page is further used to display an analysis panel, wherein analysis content of the language model for the first dashboard is displayed in the analysis panel, and the analysis content comprises at least one selected from the group consisting of a generation progress of the first dashboard, an analysis objective of the first dashboard, an analysis process of the first dashboard, a layout status of the first dashboard, and a generation status of the at least one first chart.

3. The method for generating a data dashboard of claim 1, further comprising:
displaying, in response to an interaction operation for the at least one first chart, at least one function control corresponding to the at least one first chart, wherein the function control is used to trigger processing for performing a corresponding function on the at least one first chart.

4. The method for generating a data dashboard of claim 3, wherein the function control comprises a configuration control; and the method further comprises:
displaying, in response to an interaction operation for the configuration control, a configuration page, wherein at least one configuration field of the at least one first chart is displayed on the configuration page;
obtaining, in response to a field value interaction operation for the configuration field, a target field value of the configuration field ; and
adjusting the at least one first chart based on the target field value of the configuration field to obtain an updated first chart.

5. The method for generating a data dashboard of claim 3, wherein the function control comprises an analysis control; and the method further comprises:
displaying, in response to an interaction operation for the analysis control, an analysis page; and
analyzing, in response to first content input in the analysis page, the at least one first chart to obtain an analysis result of the at least one first chart.

6. The method for generating a data dashboard of claim 3, wherein the function control comprises a search control; and the method further comprises:
displaying, in response to an interaction operation for the search control, a search page; and
performing, in response to second content input in the search page, search to obtain a second chart related to the at least one first chart.

7. The method for generating a data dashboard of claim 3, wherein the function control comprises a beautification control; and the method further comprises:
displaying, in response to an interaction operation for the beautification control, an editing page; and
performing, in response to third content input in the editing page, a beautification operation on the at least one first chart to obtain an updated first chart.

8. The method for generating a data dashboard of claim 1, wherein a chart control is further displayed on the dashboard display page; and the method further comprises:
adding, in response to interaction information for the chart control, a chart container to the first dashboard , wherein the chart container comprises a second generation control and a corresponding input control, and the second generation control corresponds to the language model;
obtaining, in response to a chart parameter input based on the input control, a target chart parameter; and
adding and displaying, in response to an interaction operation for the second generation control, a third chart in the chart container, wherein the third chart is generated by the language model based on the target chart parameter.

9. The method for generating a data dashboard of claim 1, wherein an auxiliary control is further displayed on the dashboard display page, and the auxiliary control is used to trigger display of at least one construction function provided by the language model.

10. The method for generating a data dashboard of claim 9, further comprising:
displaying, in response to an interaction operation for the auxiliary control, the at least one construction function on an auxiliary page; and
triggering, in response to a selection operation for a target construction function in the at least one construction function, processing of the target construction function.

11. The method for generating a data dashboard of claim 10, wherein the at least one construction function comprises a first creation function for creating a dashboard through a dataset; and the triggering, in response to the selection operation for the target construction function in the at least one construction function, the processing of the target construction function comprises:
displaying, in response to a selection operation for the first creation function, a second configuration area , wherein the second configuration area comprises a second configuration item of at least one second construction parameter, and the at least one second construction parameter comprises the dataset;
obtaining, in response to a configuration operation for the second configuration item, second construction information; and
adding and displaying, in response to the second construction information, a second dashboard on the dashboard display page , wherein the second dashboard is generated by the language model based on the second construction information.

12. The method for generating a data dashboard of claim 10, wherein the at least one construction function comprises a second creation function for creating a dashboard through a chart; and the triggering, in response to the selection operation for the target construction function in the at least one construction function, the processing of the target construction function comprises:
displaying, in response to a selection operation for the second creation function, a third configuration area, wherein the third configuration area comprises a third configuration item of at least one third construction parameter, and the at least one third construction parameter comprises a selected chart;
obtaining, in response to a configuration operation for the third configuration item, third construction information ; and
adding and displaying, in response to the third construction information, a third dashboard on the dashboard display page, wherein the third dashboard is generated by the language model based on the third construction information.

13. The method for generating a data dashboard of claim 10, wherein the at least one construction function comprises a layout function; and the triggering, in response to the selection operation for the target construction function in the at least one construction function, the processing of the target construction function comprises:
displaying, in response to a selection operation for the layout function, a fourth configuration area; and
adjusting, in response to layout information input in the fourth configuration area, a layout status of the first dashboard to obtain an updated first dashboard.

14. The method for generating a data dashboard of claim 13, wherein at least one of the following objects are displayed in the fourth configuration area: at least one optional layout mode and at least one piece of recommended layout information.

15. The method for generating a data dashboard of claim 10, wherein the at least one construction function comprises an interpretation function; and the triggering, in response to the selection operation for the target construction function in the at least one construction function, the processing of the target construction function comprises:
displaying, in response to a selection operation for the interpretation function, a fifth configuration area; and
obtaining, input in the fifth configuration area, interpretation content of the to-be-interpreted first chart .

16. An electronic device, comprising:
a memory and a processor, wherein the memory is communicatively connected to the processor, the memory is configured to store computer instructions, and the processor executes the computer instructions to implement a method for generating a data dashboard,
wherein the method for generating a data dashboard comprises:
displaying a dashboard creation page, wherein a first generation control and a corresponding first configuration area are displayed on the dashboard creation page, the first generation control corresponds to a language model, and a first configuration item of at least one first construction parameter of a dashboard is provided in the first configuration area;
obtaining, in response to a configuration operation for the first configuration item, first construction information; and
displaying, in response to an interaction operation for the first generation control, a first dashboard on a dashboard display page, wherein the first dashboard comprises at least one first chart, and the at least one first chart is generated by the language model based on the first construction information.

17. The electronic device of claim 16, wherein the dashboard display page is further used to display an analysis panel, wherein analysis content of the language model for the first dashboard is displayed in the analysis panel, and the analysis content comprises at least one selected from the group consisting of a generation progress of the first dashboard, an analysis objective of the first dashboard, an analysis process of the first dashboard, a layout status of the first dashboard, and a generation status of the at least one first chart.

18. The electronic device of claim 16, further comprising:
displaying, in response to an interaction operation for the at least one first chart, at least one function control corresponding to the at least one first chart, wherein the function control is used to trigger processing for performing a corresponding function on the at least one first chart.

19. The electronic device of claim 18, wherein the function control comprises a configuration control; and the method further comprises:
displaying, in response to an interaction operation for the configuration control, a configuration page, wherein at least one configuration field of the at least one first chart is displayed on the configuration page;
obtaining, in response to a field value interaction operation for the configuration field, a target field value of the configuration field ; and
adjusting the at least one first chart based on the target field value of the configuration field to obtain an updated first chart.

20. A non-transitory computer-readable storage medium storing computer instructions, wherein the computer instructions are configured to enable a computer to perform a method for generating a data dashboard,
wherein the method for generating a data dashboard comprises:
displaying a dashboard creation page, wherein a first generation control and a corresponding first configuration area are displayed on the dashboard creation page, the first generation control corresponds to a language model, and a first configuration item of at least one first construction parameter of a dashboard is provided in the first configuration area;
obtaining, in response to a configuration operation for the first configuration item, first construction information; and
displaying, in response to an interaction operation for the first generation control, a first dashboard on a dashboard display page, wherein the first dashboard comprises at least one first chart, and the at least one first chart is generated by the language model based on the first construction information.
